(19) United States
(12) Patent Application Publication
(10) Pub. No.: US 2022/0056380 A1
(43) Pub. Date: Feb. 24, 2022

(54) CLEANING COMPOSITION

(71) Applicant: The Procter & Gamble Company, Cincinnati, OH (US)

(72) Inventor: Renae Dianna Fossum, Middletown, OH (US)

(21) Appl. No.: 17/520,820

(22) Filed: Nov. 8, 2021

Related U.S. Application Data
(63) Continuation of application No. PCT/US2020/039496, filed on Jun. 25, 2020.
(60) Provisional application No. 62/868,136, filed on Jun. 28, 2019.

(51) Int. Cl. C11D 3/386; C11D 11/00; C11D 1/831; C11D 3/00; C11D 3/20; C11D 3/37

(52) U.S. Cl. CPC C11D 3/38636; C11D 11/0017; C11D 1/831; C11D 3/0089; C11D 3/0021; C11D 1/29; C11D 3/2079; C11D 3/2086; C11D 3/3788; C11D 3/3723; C11D 3/38645

(57) ABSTRACT

The present disclosure relates generally to cleaning compositions and, more specifically, to cleaning compositions containing a mannanase enzyme at a level of from 0.0001% to 2% pure enzyme by weight of total composition and an xyloglucanase enzyme.

### TECHNICAL FIELD

The present disclosure relates generally to cleaning compositions and, more specifically, to cleaning compositions containing a combination of enzymes with polymers that is suitable for removal of stains from soiled materials.

### BACKGROUND

Modern laundry detergent and/or fabric care compositions contain various detergent ingredients having one or more purposes in obtaining fabrics which are not only clean but also have retained appearance and integrity. Therefore, detergent components such as perfumes, soil release agents, fabric brightening agents, fabric softeners, chelants, bleaching agents and catalysts, dye fixatives and enzymes, have been incorporated in laundry detergent and/or fabric care compositions. One such specific example is the use of enzymes, especially proteases, lipases, amylases and/or cellulases.

Proteases are commonly used enzymes in cleaning applications. Proteases are known for their ability to hydrolyse other proteins. This ability has been taken advantage of through the incorporation of naturally occurring or engineered protease enzymes in laundry detergent compositions.

The inclusion of lipolytic enzymes in detergent compositions for improved cleaning performance is known, e.g. enhancement of removal of triglycerides containing soils and stains from the fabrics.

Amylase enzymes have long been recognized in detergent compositions to provide the removal of starchy food residues or starchy films from dishware or hard surfaces or to provide cleaning performance on starchy soils as well as other soils typically encountered in laundry applications.

Stain removal is an important aspect of detergents, and sebum stains are believed to be predictive of body soil stains in real item cleaning. Even with the inclusion of protease and amylase, there is still room for improvement for the removal of sebum stains.

Accordingly, there remains a need for laundry detergent and/or fabric care enzymes which have improved performance during typical washing/fabric care cycles when cleaning sebum stains.

### SUMMARY

The present disclosure attempts to solve one more of the needs by providing a composition comprising a detergent ingredient, a mannanase enzyme at a level of from 0.0001% to 2% pure enzyme by weight of total composition and at least one or more cellulase enzymes where the cellulase is selected from a an endoglucanse (endolase) or xyloglucanase enzyme.

The present disclosure further describes a detergent composition comprising a detergent ingredient, a mannanase enzyme at a level of from 0.0001% to 2% pure enzyme by weight of total composition and a graft copolymer. The present disclosure further describes a detergent composition comprising a detergent ingredient, a mannanase enzyme at a level of from 0.0001% to 2% pure enzyme by weight of total composition, a cellulase and a graft copolymer.

### DETAILED DESCRIPTION

Features and benefits of the present invention will become apparent from the following description, which includes examples intended to give a broad representation of the invention. Various modifications will be apparent to those skilled in the art from this description and from practice of the invention. The scope is not intended to be limited to the particular forms disclosed and the invention covers all modifications, equivalents, and alternatives falling within the spirit and scope of the invention as defined by the claims.

As used herein, the articles including “the,” “a” and “an” when used in a claim or in the specification, are understood to mean one or more of what is claimed or described.

As used herein, the terms “include,” “includes” and “including” are meant to be non-limiting.

The term “substantially free of” or “substantially free from” as used herein refers to either the complete absence of an ingredient or a minimal amount thereof merely as impurity or unintended byproduct of another ingredient. A composition that is “substantially free” of/from a component means that the composition comprises less than about 0.5%, 0.25%, 0.1%, 0.05%, or 0.01%, or even 0%, by weight of the composition, of the component.

As used herein the phrases “detergent composition” and “cleaning composition” are used interchangeably and include compositions and formulations designed for cleaning soiled material. Such compositions include but are not limited to, laundry cleaning compositions and detergents, fabric softening compositions, fabric enhancing compositions, fabric freshening compositions, laundry prewash, laundry pretreat, laundry additives, spray products, dry cleaning agent or composition, laundry rinse additive, wash additive, post-rinse fabric treatment, ironing aid, hard surface cleaning compositions, unit dose formulation, delayed delivery formulation, detergent contained on or in a porous substrate or nonwoven sheet, and other suitable forms that may be apparent to one skilled in the art in view of the teachings herein. Such compositions may be used as a pre-laundering treatment, a post-laundering treatment, or may be added during the rinse or wash cycle of the laundering operation.

The term “linear” refers to a straight chain, non-branched hydrocarbon.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

All cited patents and other documents are, in relevant part, incorporated by reference as if fully restated herein. The citation of any patent or other document is not an admission that the cited patent or other document is prior art with respect to the present invention.

In this description, all concentrations and ratios are on a weight basis of the detergent composition unless otherwise specified.

### Composition

The compositions of the present disclosure may be detergent compositions, more specifically laundry detergent compositions. The compositions may have a form selected from liquid, powder, single-phase or multi-phase unit dose, pouch, tablet, gel, paste, bar, flake. The compositions may have a form selected from the group consisting of a liquid laundry detergent, a gel detergent, a single-phase or multi-phase unit dose detergent, a detergent contained in a single-phase or multi-phase or multi-compartment water-soluble pouch, a laundry pretreat product, a fabric softener composition, and mixtures thereof.

The term “liquid” encompasses aqueous compositions, non-aqueous compositions, gels, pastes, dispersions and the like. The phrase “laundry detergent composition,” as used herein, means a composition that can be used in a laundry wash and/or rinse operation. A laundry detergent composition can also be a laundry pre-treatment composition. The composition may be a liquid laundry detergent composition that is present in a water-soluble unit dose article.

The compositions of the present disclosure may be detergent compositions and may comprise a combination of enzymes designed for the removal of sebum stains.

Surfactant

The compositions disclosed herein may comprise a surfactant selected from the group consisting of anionic surfactants, nonionic surfactants, cationic surfactants, zwitterionic surfactants, amphoteric surfactants, ampholytic surfactants, and mixtures thereof.

Anionic Surfactant

The compositions of the present disclosure may comprise at least about 10%, or at least about 20%, or at least about 30%, or at least about 50%, or at least about 60%, or at least about 70% by weight of an anionic surfactant. The compositions of the present disclosure may comprise less than 100%, or less than 90%, or less than about 85%, or less than about 75%, or less than about 70% by weight of an anionic surfactant. The compositions of the present disclosure may comprise from about 10% to about 50%, or about 20% to about 70%, or about 30% to about 75%, or about 30% to about 65%, or about 35% to about 65%, or about 40% to about 60%, of an anionic surfactant.

The anionic surfactants may exist in an acid form, and the acid form may be neutralized to form a surfactant salt. Typical agents for neutralization include metal counterion bases, such as hydroxides, e.g., NaOH or KOH. Further suitable agents for neutralizing anionic surfactants in their acid forms include ammonia, amines, or alkanolamines. Non-limiting examples of alkanolamines include monoethanolamine, diethanolamine, triethanolamine, and other linear or branched alkanolamines known in the art; suitable alkanolamines include 2-amino-1-propanol, 1-aminopropanol, monoisopropanolamine, or 1-amino-3-propanol. Amine neutralization may be done to a full or partial extent, e.g., part of the anionic surfactant mix may be neutralized with sodium or potassium and part of the anionic surfactant mix may be neutralized with amines or alkanolamines.

Non-limiting examples of suitable anionic surfactants include any conventional anionic surfactant. This may include a sulfate detersive surfactant, for e.g., alkoxylated and/or non-alkoxylated alkyl sulfate materials, and/or sulfonic detersive surfactants, e.g., alkyl benzene sulfonates. Suitable anionic surfactants may be derived from renewable resources, waste, petroleum, or mixtures thereof. Suitable anionic surfactants may be linear, partially branched, branched, or mixtures thereof

Alkoxylated alkyl sulfate materials comprise ethoxylated alkyl sulfate surfactants, also known as alkyl ether sulfates or alkyl polyethoxylate sulfates. Examples of ethoxylated alkyl sulfates include water-soluble salts, particularly the alkali metal, ammonium and alkylolammonium salts, of organic sulfuric reaction products having in their molecular structure an alkyl group containing from about 8 to about 30 carbon atoms and a sulfonic acid and its salts. (Included in the term “alkyl” is the alkyl portion of acyl groups. In some examples, the alkyl group contains from about 15 carbon atoms to about 30 carbon atoms. In other examples, the alkyl ether sulfate surfactant may be a mixture of alkyl ether sulfates, said mixture having an average (arithmetic mean) carbon chain length within the range of about 12 to 30 carbon atoms, and in some examples an average carbon chain length of about 12 to 15 carbon atoms, and an average (arithmetic mean) degree of ethoxylation of from about 1 mol to 4 mols of ethylene oxide, and in some examples an average (arithmetic mean) degree of ethoxylation of 1.8 mols of ethylene oxide. In further examples, the alkyl ether sulfate surfactant may have a carbon chain length between about 10 carbon atoms to about 18 carbon atoms, and a degree of ethoxylation of from about 1 to about 6 mols of ethylene oxide. In yet further examples, the alkyl ether sulfate surfactant may contain a peaked ethoxylate distribution.

Non-alkoxylated alkyl sulfates may also be added to the disclosed detergent compositions and used as an anionic surfactant component. Examples of non-alkoxylated, e.g., non-ethoxylated, alkyl sulfate surfactants include those produced by the sulfation of higher C₈-C₂₀ fatty alcohols. In some examples, primary alkyl sulfate surfactants have the general formula: ROSO₃⁻M⁺, wherein R is typically a linear C₈-C₂₀ hydrocarbyl group, which may be straight chain or branched chain, and M is a water-solubilizing cation. In some examples, R is a C₁₀-C₁₈ alkyl, and M is an alkali metal. In other examples, R is a C₁₂/C₁₄ alkyl and M is sodium, such as those derived from natural alcohols.

Other useful anionic surfactants can include the alkali metal salts of alkyl benzene sulfonates, in which the alkyl group contains from about 9 to about 15 carbon atoms, in straight chain (linear) or branched chain configuration. In some examples, the alkyl group is linear. Such linear alkylbenzene sulfonates are known as “LAS.” In other examples, the linear alkylbenzene sulfonate may have an average number of carbon atoms in the alkyl group of from about 11 to 14. In a specific example, the linear straight chain alkyl benzene sulfonates may have an average number of carbon atoms in the alkyl group of about 11.8 carbon atoms, which may be abbreviated as C11.8 LAS.

Suitable alkyl benzene sulphonate (LAS) may be obtained, by sulphonating commercially available linear alkyl benzene (LAB); suitable LAB includes low 2-phenyl LAB, such as those supplied by Sasol under the tradename Isochem® or those supplied by Petresa under the tradename Petrelab®, other suitable LAB include high 2-phenyl LAB, such as those supplied by Sasol under the tradename Hyblene®. A suitable anionic detersive surfactant is alkyl benzene sulphonate that is obtained by DETAL catalyzed process, although other synthesis routes, such as HF, may also be suitable. In one aspect a magnesium salt of LAS is used.

Another example of a suitable alkyl benzene sulfonate is a modified LAS (MLAS), which is a positional isomer that contains a branch, e.g., a methyl branch, where the aromatic ring is attached to the 2 or 3 position of the alkyl chain.

The anionic surfactant may include a 2-alkyl branched primary alkyl sulfates have 100% branching at the C2 position (C1 is the carbon atom covalently attached to the alkoxylated sulfate moiety). 2-alkyl branched alkyl sulfates and 2-alkyl branched alkyl alkoxy sulfates are generally derived from 2-alkyl branched alcohols (as hydrophobes). 2-alkyl branched alcohols, e.g., 2-alkyl-1-alkanols or 2-alkyl primary alcohols, which are derived from the oxo process, are commercially available from Sasol, e.g., LIAL®, ISALCHEM® (which is prepared from LIAL® alcohols by a fractionation process). C14/C15 branched primary alkyl sulfate are also commercially available, e.g., namely LIAL® 145 sulfate.

The anionic surfactant may include a mid-chain branched anionic surfactant, e.g., a mid-chain branched anionic detersive surfactant, such as, a mid-chain branched alkyl sulphate and/or a mid-chain branched alkyl benzene sulphonate.

Additional suitable anionic surfactants include methyl ester sulfonates, paraffin sulfonates, α-olefin sulfonates, and internal olefin sulfonates.

The compositions disclosed herein may comprise an anionic surfactant selected from the group consisting of linear or branched alkyl benzene sulfonates, linear or branched alkoxylated alkyl sulfates, linear or branched alkyl sulfates, methyl ester sulfonates, paraffin sulfonates, α-olefin sulfonates, internal olefin sulfonates, and mixtures thereof. The compositions disclosed herein may comprise an anionic surfactant selected from the group consisting of linear or branched alkyl benzene sulfonates, linear or branched alkoxylated alkyl sulfates, linear or branched alkyl sulfates, and mixtures thereof. The compositions disclosed herein may comprise a 2-alkyl branched primary alkyl sulfate.

Nonionic Surfactant

The compositions disclosed herein may comprise a nonionic surfactant. Suitable nonionic surfactants include alkoxylated fatty alcohols. The nonionic surfactant may be selected from ethoxylated alcohols and ethoxylated alkyl phenols of the formula R(OC₂H₄)ₙOH, wherein R is selected from the group consisting of aliphatic hydrocarbon radicals containing from about 8 to about 15 carbon atoms and alkyl phenyl radicals in which the alkyl groups contain from about 8 to about 12 carbon atoms, and the average value of n is from about 5 to about 15.

Other non-limiting examples of nonionic surfactants useful herein include: C₈-C₁₈ alkyl ethoxylates, such as, NEODOL® nonionic surfactants from Shell; C₆-C₁₂ alkyl phenol alkoxylates where the alkoxylate units may be ethyleneoxy units, propyleneoxy units, or a mixture thereof; C₁₂-C₁₈ alcohol and C₆-C₁₂ alkyl phenol condensates with ethylene oxide/propylene oxide block polymers such as Pluronic® from BASF; C₁₄-C₂₂ mid-chain branched alcohols, BA; C₁₄-C₂₂ mid-chain branched alkyl alkoxylates, BAEₓ, wherein x is from 1 to 30; alkylpolysaccharides; specifically alkylpolyglycosides; polyhydroxy fatty acid amides; and ether capped poly(oxyalkylated) alcohol surfactants.

Suitable nonionic detersive surfactants also include alkyl polyglucoside and alkyl alkoxylated alcohol. Suitable nonionic surfactants also include those sold under the tradename Lutensol® from BASF.

Cationic Surfactant

The compositions disclosed herein may comprise a cationic surfactant. Non-limiting examples of cationic surfactants include: the quaternary ammonium surfactants, which can have up to 26 carbon atoms include: alkoxylate quaternary ammonium (AQA) surfactants; dimethyl hydroxyethyl quaternary ammonium; dimethyl hydroxyethyl lauryl ammonium chloride;

polyamine cationic surfactants; cationic ester surfactants; and amino surfactants, e.g., amido propyldimethyl amine (APA).

Suitable cationic detersive surfactants also include alkyl pyridinium compounds, alkyl quaternary ammonium compounds, alkyl quaternary phosphonium compounds, alkyl ternary sulphonium compounds, and mixtures thereof.

Suitable cationic detersive surfactants are quaternary ammonium compounds having the general formula:

(R)(R₁)(R₂)(R₃)N⁺X⁻

wherein, R is a linear or branched, substituted or unsubstituted C₆₋₁₈ alkyl or alkenyl moiety, R₁ and R₂ are independently selected from methyl or ethyl moieties, R₃ is a hydroxyl, hydroxymethyl or a hydroxyethyl moiety, X is an anion which provides charge neutrality, suitable anions include: halides, for example chloride; sulphate; and sulphonate. Suitable cationic detersive surfactants are mono-C₆₋₁₈ alkyl mono-hydroxyethyl di-methyl quaternary ammonium chlorides. Highly suitable cationic detersive surfactants are mono-C₈₋₁₀ alkyl mono-hydroxyethyl di-methyl quaternary ammonium chloride, mono-C₁₀₋₁₂ alkyl mono-hydroxyethyl di-methyl quaternary ammonium chloride and mono-C₁₀ alkyl mono-hydroxyethyl di-methyl quaternary ammonium chloride.

Zwitterionic Surfactant

The compositions disclosed herein may comprise a zwitterionic surfactant. Examples of zwitterionic surfactants include: derivatives of secondary and tertiary amines, derivatives of heterocyclic secondary and tertiary amines, or derivatives of quaternary ammonium, quaternary phosphonium or tertiary sulfonium compounds. Suitable examples of zwitterionic surfactants include betaines, including alkyl dimethyl betaine and cocodimethyl amidopropyl betaine, C₈ to C₁₈ (for example from C₁₂ to C₁₈) amine oxides, and sulfo and hydroxy betaines, such as N-alkyl-N,N-dimethylammino-1-propane sulfonate where the alkyl group can be C₈ to C₁₈.

Amphoteric Surfactant

The compositions disclosed herein may comprise an amphoteric surfactant. Examples of amphoteric surfactants include aliphatic derivatives of secondary or tertiary amines, or aliphatic derivatives of heterocyclic secondary and tertiary amines in which the aliphatic radical may be straight or branched-chain and where one of the aliphatic substituents contains at least about 8 carbon atoms, or from about 8 to about 18 carbon atoms, and at least one of the aliphatic substituents contains an anionic water-solubilizing group, e.g. carboxy, sulfonate, sulfate. Suitable amphoteric surfactants also include sarcosinates, glycinates, taurinates, and mixtures thereof.

Enzyme System

The cleaning compositions of the present disclosure comprise an enzyme system. The enzyme system may be present in the cleaning composition at a level of from about 0.0001% to about 5%, or from about 0.001% to about 2%, by weight of the cleaning composition. The enzyme system may comprise of mannanase enzyme at level of from about 0.0001% to about 2% by weight of the cleaning composition such as, for example, from about 0.001% to about 1.5%, from about 0.009% to about 1.2%, from about 0.01% to about 1% and one or more cellulase enzymes at a level of from about 0.0001% to about 2% such as, for example, from about 0.001% to about 1.5%, from about 0.009% to about 1.2%, from about 0.01% to about 1% by weight of the cleaning composition.

The enzyme system comprises a plurality of enzymes. The enzymes may be provided individually, or they may be provided as a combination, such as in a premix that contains a plurality of enzymes.

The enzyme system contains mannanase enzyme. The system may further additionally comprise one or more cellulase enzyme. It has been surprisingly found that the combination of mannanase with one or more cellulase enzymes surprisingly improves the ability to remove sebum stains from fabrics. The enzyme system may comprise mannanase enzyme at a level of from 0.0001% to 2% such as, for example, from about 0.001% to about 1.5%, from about 0.009% to about 1.2%, from about 0.01% to about 1% pure enzyme by weight of the total composition. The enzyme system may comprise one or more cellulose enzymes each at a level of from 0.0001% to 2% such as, for example, from about 0.001% to about 1.5%, from about 0.009% to about 1.2%, from about 0.01% to about 1% pure enzyme by weight of the total composition selected from the group consisting of a xyloglucanase enzyme and any mutations thereof and an endoglucanase (endolase) enzyme and any mutations thereof.

The enzyme system may further comprise a polymer. Specifically, the enzyme system may further comprise a graft polymer as described below.

### Cellulases

The consumer products can comprise cellulases of bacterial or fungal origin. Chemically modified or protein engineered mutants are included. Suitable cellulases include cellulases from the genera Bacillus, Pseudomonas, Humicola, Fusarium, Thielavia, Acremonium, e.g., the fungal cellulases produced from Humicola insolens, Myceliophthora thermophila and Fusarium oxysporum disclosed in U.S. Pat. Nos. 4,435,307, 5,648,263, 5,691,178, 5,776,757 and 5,691,178. Suitable cellulases include the alkaline or neutral cellulases having colour care benefits. Commercially available cellulases include CELLUZYME®, CAREZYME® and CAREZYME PREMIUM (Novozymes A/S), CLAZINASE®, and PURADAX HA® (Genencor International Inc.), and KAC-500(B)® (Kao Corporation).

Preferred cellulases include:
a) Variants exhibiting at least 60% identity to SEQ ID NO: 2 in WO2017084560. Preferred substitutions comprise one or more positions corresponding to positions 292, 274, 266, 265, 255, 246, 237, 224 a nd 221 of the mature polypeptide of SEQ ID NO: 2, and the variant has cellulase activity.
b) Variants exhibiting at least 70% identity with SEQ ID NO: 5 in WO2017106676. Preferred substitutions comprise one or more positions corresponding to positions 4, 20, 23, 29, 32, 36, 44, 51, 77, 80, 87, 90, 97, 98, 99, 102, 112, 116, 135, 136, 142, 153, 154, 157, 161, 163, 192, 194, 204, 208, 210, 212, 216, 217, 221, 222, 225, 227, and 232.

The bacterial cleaning cellulase may be a glycosyl hydrolase having enzymatic activity towards amorphous cellulose substrates, wherein the glycosyl hydrolase is selected from GH families 5, 7, 12, 16, 44 or 74. Suitable glycosyl hydrolases may also be selected from the group consisting of: GH family 44 glycosyl hydrolases from Paenibacillus polyxyma (wild-type) such as XYG1006 described in U.S. Pat. No. 7,361,736 or are variants thereof. GH family 12 glycosyl hydrolases from Bacillus licheniformis (wild-type) such as SEQ ID NO:1 described in U.S. Pat. No. 6,268,197 or are variants thereof; GH family 5 glycosyl hydrolases from Bacillus agaradhaerens (wild type) or variants thereof; GH family 5 glycosyl hydrolases from Paenibacillus (wild type) such as XYG1034 and XYG 1022 described in U.S. Pat. No. 6,630,340 or variants thereof; GH family 74 glycosyl hydrolases from Jonesia sp. (wild type) such as XYG1020 described in WO 2002/077242 or variants thereof; and GH family 74 glycosyl hydrolases from Trichoderma Reesei (wild type), such as the enzyme described in more detail in Sequence ID NO. 2 of U.S. Pat. No. 7,172,891, or variants thereof. Suitable bacterial cleaning cellulases are sold under the tradenames Celluclean® and Whitezyme® (Novozymes A/S, Bagsvaerd, Denmark).

In one aspect, the composition may comprise a fungal cleaning cellulase belonging to glycosyl hydrolase family 45 having a molecular weight of from 17 kDa to 30 kDa, for example the endoglucanases sold under the tradename Biotouch® NCD, DCC, DCL and FLX1 (AB Enzymes, Darmstadt, Germany). Additionally, preferred cellulases include the ones covered in WO2016066896.

### Mannanase

As used herein, the term “mannanase” or “galactomannanase” denotes a mannanase enzyme defined according to that known in the art as mannan endo-1,4-beta-mannosidase and having the alternative names beta-mannanase and endo-1,4-mannanase and catalysing hydrolysis of 1,4-beta-D-mannosidic linkages in mannans, galactomannans, glucomannans, and galactoglucomannans. Mannanases are classified according to the Enzyme Nomenclature as EC 3.2.1.78.

Suitable mannanase can be selected from the group consisting of:
a) mannanase having mannanase activity and a polypeptide having at least 85% sequence identity to residues 27-331 of SEQ ID NO: 3. SEQ ID NO: 3 corresponds to the full-length amino acid sequence of the Man7 mannanase endogenous to Bacillus hemicellulosilyticus including a signal sequence;
b) mannanase has mannanase activity and a polypeptide having at least 60% identity to SEQ ID NO: 4. In one embodiment of the invention, the mannanase has mannanase activity and a polypeptide having at least 80% identity to SEQ ID NO: 4. SEQ ID NO: 4 corresponds to the full-length amino acid sequence of the Man4 mannanase endogenous to Paenibacillus sp;
c) mannanase from the glycoside hydrolase family 26 that catalyze the hydrolysis of 1,4-3-D-mannosidic linkages in mannans, galactomannans and glucomannans. Suitable examples are described in WO2015040159.

Additional preferred mannanases include those sold under the tradenames Mannaway® (all from Novozymes A/S, Bagsvaerd, Denmark), and Purabrite®, Effectenz®, Preferenz® (Genencor International Inc., Palo Alto, Calif.) and Biotouch® (AB Enzymes, Darmstadt, Germany).

### Proteases

The composition of the invention can comprise a protease in addition to the protease of the invention. A mixture of two or more proteases can contribute to an enhanced cleaning across a broader temperature, cycle duration, and/or substrate range, and provide superior shine benefits, especially when used in conjunction with an anti-redeposition agent and/or a sulfonated polymer.

Suitable proteases for use in combination with the variant proteases of the invention include metalloproteases and serine proteases, including neutral or alkaline microbial serine proteases, such as subtilisins (EC 3.4.21.62). Suitable proteases include those of animal, vegetable or microbial origin. In one aspect, such suitable protease may be of microbial origin.

Preferred levels of protease in the product of the invention include from about 0.05 to about 10, more preferably from about 0.5 to about 7 and especially from about 1 to about 6 mg of active protease/g of composition.

### Amylases

Preferably the composition of the invention may comprise an amylase. Suitable alpha-amylases include those of bacterial or fungal origin. Chemically or genetically modified mutants (variants) are included. A preferred alkaline alpha-amylase is derived from a strain of Bacillus, such as Bacillus licheniformis, Bacillus amyloliquefaciens, Bacillus stearothermophilus, Bacillus subtilis, or other Bacillus sp., such as Bacillus sp. NCBI 12289, NCBI 12512, NCBI 12513, DSM 9375 (U.S. Pat. No. 7,153,818) DSM 12368, DSMZ no. 12649, KSM AP1378 (WO 97/00324), KSM K36 or KSM K38 (EP 1,022,334).

Preferably, the product of the invention comprises at least 0.01 mg, preferably from about 0.05 to about 10, more preferably from about 0.1 to about 6, especially from about 0.2 to about 5 mg of active amylase/g of composition.

Preferably, the protease and/or amylase of the composition of the invention are in the form of granulates, the granulates comprise more than 29% of sodium sulfate by weight of the granulate and/or the sodium sulfate and the active enzyme (protease and/or amylase) are in a weight ratio of between 3:1 and 100:1 or preferably between 4:1 and 30:1 or more preferably between 5:1 and 20:1.

### Lipase

The enzyme system preferably further comprises a lipase. The presence of oils and/or grease can further increase the resiliency of stains comprising mannans and other polysaccharides. As such, the presence of lipase in the enzyme package can further improve the removal of such stains. Suitable lipases include those of bacterial, fungal or synthetic origin, and variants thereof. Chemically modified or protein engineered mutants are also suitable. Examples of suitable lipases include lipases from Humicola (synonym Thermomyces), e.g., from H. lanuginosa (T. lanuginosus).

### Pectate Lyases.

Other preferred enzymes include pectate lyases sold under the tradenames Pectawash®, Pectaway®, Xpect®.

### Nuclease Enzyme.

The composition may comprise a nuclease enzyme. The nuclease enzyme is an enzyme capable of cleaving the phosphodiester bonds between the nucleotide sub-units of nucleic acids. The enzyme system may comprise an extracellular polymer-degrading enzyme that includes an endo-beta-1,6-galactanase enzyme.

### Other Enzymes

The enzyme system can comprise other enzymes. Suitable enzymes provide cleaning performance and/or fabric care benefits. Examples of other suitable enzymes include, but are not limited to, hemicellulases, peroxidases, proteases, amylase, other cellulases, pectate lyases, xylanases, lipases, phospholipases, esterases, cutinases, pectinases, keratanases, reductases, oxidases, phenoloxidases, lipoxygenases, ligninases, pullulanases, tannases, pentosanases, malanases, nucleases, ß-glucanases, arabinosidases, hyaluronidase, chondroitinase, laccase, and known amylases, or combinations thereof. A preferred enzyme system further comprises a cocktail of conventional detersive enzymes such as protease, lipase, cutinase and/or cellulase in conjunction with amylase. Detersive enzymes are described in greater detail in U.S. Pat. No. 6,579,839.

### Enzyme Stabilizing System

The compositions may optionally comprise from about 0.001% to about 10%, or from about 0.005% to about 8%, or from about 0.01% to about 6%, by weight of the composition, of an enzyme stabilizing system. The enzyme stabilizing system can be any stabilizing system which is compatible with the detersive enzyme. Such a system may be inherently provided by other formulation actives, or be added separately, e.g., by the formulator or by a manufacturer of detergent-ready enzymes. Such stabilizing systems can, for example, comprise calcium ion, boric acid, propylene glycol, diethylene glycol, 2-methyl-1,3-propane diol, glycerol, sorbitol, calcium formate, short chain carboxylic acids, boronic acids, chlorine bleach scavengers and mixtures thereof, and are designed to address different stabilization problems depending on the type and physical form of the detergent composition. In the case of aqueous detergent compositions comprising protease, a reversible protease inhibitor, such as a boron compound, including borate, 4-formyl phenylboronic acid, phenylboronic acid and derivatives thereof, or compounds such as calcium formate, sodium formate and 1,2-propane diol may be added to further improve stability

### Graft Copolymer

The compositions and methods of the present disclosure relate to a graft polymer. Broadly, the graft polymer may comprise and/or be obtainable by grafting either (a) a polyalklyene oxide with (b) N-vinylpyrrolidone and (c) a vinyl ester or by grafting (a) a polyalklyene oxide with (b) a vinyl ester. The graft polymer is described in more detail below.

Compositions according to the present disclosure may include from about 0.1% to about 50%, or to about 40%, or to about 25%, or from about 0.1% to about 15%, or from about 0.1% to about 10%, or from about 0.2% to about 5%, or from about 0.5% to about 7% by weight of the composition, of the graft polymer. The graft polymer may be present in an aqueous treatment liquor, such as a wash liquor or a rinse liquor of an automatic washing machine, in an amount of about 5 ppm, or from about 10 ppm, or from about 25 ppm, or from about 50 ppm, to about 1500 ppm, or to about 1000 ppm, or to about 500 ppm, or to about 250 ppm.

The graft polymer may be comprise and/or be obtainable by grafting (a) a polyalkylene oxide which has a number average molecular weight of from about 1000 to about 20,000, or to about 15,000, or to about 12,000, or to about 10,000 Daltons and is based on ethylene oxide, propylene oxide, or butylene oxide, preferably based on ethylene oxide, with (b) N-vinylpyrrolidone, and further with (c) a vinyl ester derived from a saturated monocarboxylic acid containing from 1 to 6 carbon atoms and/or a methyl or ethyl ester of acrylic or methacrylic acid, preferably a vinyl ester that is vinyl acetate or a derivative thereof; where the weight ratio of (a):(b) is from about 1:0.1 to about 1:1; where the amount, by weight, of (a) is greater than the amount of (c); and where the order of the addition of monomers (b) and (c) in the graft polymerization is immaterial.

The graft polymer may comprise and/or be obtainable by grafting (a) an alkylene oxide which has a number average molecular weight of from about 1000 to 20,000, or to about 15,000, or to about 12,000, or to about 10,000 Daltons, the alkylene oxide being based on ethylene oxide, with (b) N-vinylpyrrolidone, and (c) vinyl acetate or a derivative thereof; wherein the weight ratio of (a):(b) is from about 1:0.1 to about 1:2, or to about 1:1; wherein the weight ratio of (b):(c) is from about 1:0.1 to about 1:5, or to about 1:4; wherein the weight ratio of (a):(c) is from about 1:0.1 to about 1:5, or to about 1:3; the order of the addition of monomers (b) and (c) in the graft polymerization being immaterial.

The graft polymer may be obtainable by grafting (a) an alkylene oxide which has a number average molecular weight of from about 1000 to 20,000, or to about 15,000, or to about 12,000, or to about 10,000 Daltons, the alkylene oxide being based on ethylene oxide, with (b) N-vinylpyrrolidone, and (c) vinyl acetate or a derivative thereof, the order of the addition of monomers (b) and (c) in the graft polymerization being immaterial, wherein the number of grafting sites is less than 1 per 50 ethylene oxide groups, wherein the composition is a fabric care composition.

The graft bases used may be the polyalkylene oxides specified above under (a). The polyalkylene oxides of component (a) may have a number average molecular weight of about 300, or from about 1000, or from about 2000, or from about 3,000, to about 20,000, or to about 15,000, or to about 12,000, or to about 10,000, or to about 8,000, or to about 6,000 Daltons (Da). Without wishing to be bound by theory, it is believed that if the molecular weight of component (a) (e.g., polyethylene glycol), is relatively low, there may be a performance decrease in dye transfer inhibition. Additionally or alternatively, when the molecular weight is too high, the polymer may not remain suspended in solution and/or may deposit on treated fabrics.

The polyalkylene oxides may be based on ethylene oxide, propylene oxide, butylene oxides, or mixtures thereof, preferably ethylene oxide. The polyalkylene oxides may be based on homopolymers of ethylene oxide or ethylene oxide copolymers having an ethylene oxide content of from about 40 to about 99 mole %. Suitable comonomers for such copolymers may include propylene oxide, n-butylene oxide, and/or isobutylene oxide. Suitable copolymers may include copolymers of ethylene oxide and propylene oxide, copolymers of ethylene oxide and butylene oxide, and/or copolymers of ethylene oxide, propylene oxide, and at least one butylene oxide. The copolymers may include an ethylene oxide content of from about 40 to about 99 mole %, a propylene oxide content of from about 1 to about 60 mole %, and a butylene oxide content of from about 1 to about 30 mole %. The graft base may be linear (straight-chain) or branched, for example a branched homopolymer and/or a branched copolymer.

Branched copolymers may be prepared by addition of ethylene oxide with or without propylene oxides and/or butylene oxides onto polyhydric low molecular weight alcohols, for example trimethylol propane, pentoses, or hexoses. The alkylene oxide unit may be randomly distributed in the polymer or be present therein as blocks.

The polyalkylene oxides of component (a) may be the corresponding polyalkylene glycols in free form, i.e, with OH end groups, or they may be capped at one or both end groups. Suitable end groups may be, for example, C1-C25-alkyl, phenyl, and C1-C14-alkylphenyl groups. The end group may be a C1-alkyl (e.g., methyl) group. Suitable materials for the graft base may include PEG 300, PEG 1000, PEG 2000, PEG 4000, PEG 6000, PEG 8000, and/or PEG 10,000 which are polyethylene glycols, and/or MPEG 2000, MPEG 4000, MPEG 6000, MPEG 8000 and MEG 10000 which are monomethoxypolyethylene glycols that are commercially available from BASF under the tradename Pluriol®.

The polyalkylene oxides may be grafted with N-vinylpyrrolidone as the monomer of component (b). Without wishing to be bound by theory, it is believed that the presence of the N-vinylpyrrolidone (“VP”) monomer in the graft polymers according to the present disclosure provides water-solubility and good film-forming properties compared to otherwise-similar polymers that do not contain the VP monomer. The vinyl pyrrolidone repeat unit has amphiphilic character with a polar amide group that can form a dipole, and a non-polar portion with the methylene groups in the backbone and the ring, making it hydrophobic. When the vinyl pyrrolidone content is too high, there may be negative interactions with other ingredients in the detergent such as brightener causing physical instability, and material cost is high with high vinyl pyrrolidone content.

The polyalkylene oxides may be grafted with a vinyl ester as the monomer of component (c). The vinyl ester may be derived from a saturated monocarboxylic acid, which may contain 1 to 6 carbon atoms, or from 1 to 3 carbon atoms, or from 1 to 2 carbon atoms, or 1 carbon atom. The vinyl ester may be derived from methyl acrylate, ethyl acrylate, methyl methacrylate, ethyl methacrylate, or mixtures thereof. Suitable vinyl esters may include vinyl formate, vinyl acetate, vinyl propionate, vinyl butyrate, vinyl valerate, vinyl iso-valerate, vinyl caproate, or mixtures thereof. Preferred monomers of component (c) include vinyl acetate, vinyl propionate, methyl acrylate, mixtures of vinyl acetate and methyl acrylate, or mixtures thereof, preferably vinyl acetate. The monomers of the graft polymer, e.g., components (a), (b), and/or (c), may be present in certain ratios, such as weight ratios and/or mole ratios.

For example, the weight ratio of (a):(b) may be from about 1:0.1 to about 1:1, or from about 1:0.2 to about 1:0.7. The weight ratio of (a):(b) may be from about 1:0.1 to about 1:2, or to about 1:1. When the VP ratio is too high, the polymer may form negative interactions with other detergent ingredients such as brightener, and/or may not work sufficiently on some hydrolyzed reactive dyes.

The weight ratio of (a):(c) may be greater than 1:1, or from about 1:0.1 to about 1:0.8, or from about 1:0.2 to about 1:0.6. The weight ratio of (a):(c) is from about 1:0.1 to about 1:5, or to about 1:3. The amount, by weight, of (a) may be greater than the amount of (c). Without wishing to be bound by theory, it is believed that relatively high levels of component (c) (e.g., vinyl acetate), particularly in relation to component (a), may result in decreased performance of dye transfer inhibition and/or relatively greater hydrophobicity, which can lead to formulation and/or stability challenges.

The weight ratio of (b):(c) may be from about 1:0.1 to about 1:5, or to about 1:4. Without wishing to be bound by theory, a ratio of VP-to-VAc that is too high may lead to treated fabric having a negative feel. Additionally, negative interactions with ingredients such as brighteners may occur.

The graft polymers of the present disclosure may be characterized by relatively low degree of branching (i.e., degree of grafting). In the graft polymers of the present disclosure, the average number of grafting sites may be less than or equal to 1, or less than or equal to 0.8, or less than or equal to 0.6, or less than or equal to 0.5, or less than or equal to 0.4, per 50 alkylene oxide groups, e.g., ethylene oxide groups. The graft polymers may comprise, on average, based on the reaction mixture obtained, at least 0.05, or at least 0.1, graft site per 50 alkylene oxide groups, e.g., ethylene oxide groups. The degree of branching may be determined, for example, by means of ¹³C NMR spectroscopy from the integrals of the signals of the graft sites and the —CH₂-groups of the polyalkylene oxide. The number of grafting sites may be adjusted by manipulating the temperature and/or the feed rate of the monomers. For example, the polymerization may be carried out in such a way that an excess of component (a) and the formed graft polymer is constantly present in the reactor. For example, the quantitative molar ratio of component (a) and polymer to ungrafted monomer (and initiator, if any) is generally greater than or equal to about 10:1, or to about 15:1, or to about 20:1.

The graft polymers of the present disclosure may be characterized by a relatively narrow molar mass distribution. For example, the graft polymers may be characterized by a polydispersity M_{w}/Mₙ of less than or equal to about 3, or less than or equal to about 2.5, or less than or equal to about 2.3. The polydispersity of the graft polymers may be from about 1.5 to about 2.2. The polydispersity may be determined by gel permeation chromatography using narrow-distribution polymethyl methacrylates as the standard.

The graft polymers may be prepared by grafting the suitable polyalkylene oxides of component (a) with the monomers of component (b) in the presence of free radical initiators and/or by the action of high-energy radiation, which may include the action of high-energy electrons. This may be done, for example, by dissolving the polyalkylene oxide in at least one monomer of group (b), adding a polymerization initiator and polymerizing the mixture to completion. The graft polymerization may also be carried out semicontinuously by first introducing a portion, for example 10%, of the mixture of polyalkylene oxide to be polymerized, at least one monomer of group (b) and/or (c) and initiator, heating to polymerization temperature and, after the polymerization has started, adding the remainder of the mixture to be polymerized at a rate commensurate with the rate of polymerization. The graft polymers may also be obtained by introducing the polyalkylene oxides of group (a) into a reactor, heating to the polymerization temperature, and adding at least one monomer of group (b) and/or (c) and polymerization initiator, either all at once, a little at a time, or uninterruptedly, preferably uninterruptedly, and polymerizing.

In the preparation of the graft polymers, the order in which the monomers (b) and (c) are grafted onto component (a) may be immaterial and/or freely chooseable. For example, first N-vinylpyrrolidone may be grafted onto component (a), and then a monomer (c) or a mixture of monomers of group (c). It is also possible to first graft the monomers of group (c) and then N-vinylpyrrolidone onto the graft base (a). It may be that a monomer mixture of (b) and (c) are grafted onto graft base (a) in one step. The graft polymer may be prepared by providing graft base (a) and then first grafting N-vinylpyrrolidone and then vinyl acetate onto the graft base.

Any suitable polymerization initiator(s) may be used, which may include organic peroxides such as diacetyl peroxide, dibenzoyl peroxide, succinyl peroxide, di-tert-butyl peroxide, tert-butyl perbenzoate, tert-butyl perpivalate, tert-butyl permaleate, cumene hydroperoxide, diisopropyl peroxodicarbamate, bis(o-toluoyl) peroxide, didecanoyl peroxide, dioctanoyl peroxide, dilauroyl peroxide, tert-butyl perisobutyrate, tert-butyl peracetate, di-tert-amyl peroxide, tert-butyl peracetate, di-tert-amyl peroxide, tert-butyl hydroperoxide, mixtures thereof, redox initiators, and/or azo starters. The choice of initiator may be related to the choice of polymerization temperature.

The graft polymerization may take place at from about 50° C. to about 200° C., or from about 70° C. to about 140° C. The graft polymerization may typically be carried out under atmospheric pressure, but may also be carried out under reduced or superatmospheric pressure.

The graft polymerization may be carried out in a solvent. Suitable solvents may include: monohydric alcohols, such as ethanol, propanols, and/or butanols; polyhydric alcohols, such as ethylene glycol and/or propylene glycol; alkylene glycol ethers, such as ethylene glycol monomethyl and -ethyl ether and/or propylene glycol monomethyl and -ethyl ether; polyalkylene glycols, such as di- or tri-ethylene glycol and/or di- or tri-propylene glycol; polyalkylene glycol monoethers, such as poly(C2-C3-alkylene)glycol mono (C1-C16-alkyl)ethers having 3-20 alkylene glycol units; carboxylic esters, such as ethyl acetate and ethyl propionate; aliphatic ketones, such as acetone and/or cyclohexanone; cyclic ethers, such as tetrahydrofuran and/or dioxane; or mixtures thereof.

The graft polymerization may also be carried out in water as solvent. In such cases, the first step may be to introduce a solution which, depending on the amount of added monomers of component (b) is more or less soluble in water. To transfer water-insoluble products that can form during the polymerization into solution, it is possible, for example, to add organic solvents, for example monohydric alcohols having 1 to 3 carbon atoms, acetone, and/or dimethylformamide. In a graft polymerization process in water, it is also possible to transfer the water-insoluble graft polymers into a finely divided dispersion by adding customary emulsifiers or protective colloids, for example polyvinyl alcohol. The emulsifiers used may be ionic or nonionic surfactants whose HLB value is from about 3 to about 13. HLB value is determined according to the method described in the paper by W. C. Griffin in J. Soc. Cosmet. Chem. 5 (1954), 249.

The amount of surfactant used in the graft polymerization process may be from about 0.1 to about 5% by weight of the graft polymer. If water is used as the solvent, solutions or dispersions of graft polymers may be obtained. If solutions of graft polymers are prepared in an organic solvent or in mixtures of an organic solvent and water, the amount of organic solvent or solvent mixture used per 100 parts by weight of the graft polymer may be from about 5 to about 200, preferably from about 10 to about 100, parts by weight.

The graft polymers may have a K value of from about 5 to about 200, preferably from about 5 to about 50, determined according to H. Fikentscher in 2% strength by weight solution in dimethylformamide at 25 C.

After the graft polymerization, the graft polymer may optionally be subjected to a partial hydrolysis. The graft polymer may include up to 60 mole %, or up to 50 mole %, or up to 40 mole %, or up to 25 mole %, or up to 20 mole %, or up to 15 mole %, or up to 10 mole %, of the grafted-on monomers of component (c) are hydrolyzed. For instance, the hydrolysis of graft polymers prepared using vinyl acetate or vinyl propionate as component (c) gives graft polymers containing vinyl alcohol units. The hydrolysis may be carried out, for example, by adding a base, such as sodium hydroxide solution or potassium hydroxide solution, or alternatively by adding acids and if necessary heating the mixture. Without wishing to be bound by theory, it is believed that increasing the level of hydrolysis of component (c) increases the relative hydrophilicity of the graft polymer.

A suitable amphilic graft co-polymer is Sokalan® HP22, supplied from BASF. Suitable polymers include random graft copolymers, preferably a polyvinyl acetate grafted polyethylene oxide copolymer having a polyethylene oxide backbone and multiple polyvinyl acetate side chains. The molecular weight of the polyethylene oxide backbone is typically about 6000 and the weight ratio of the polyethylene oxide to polyvinyl acetate is about 40 to 60 and no more than 1 grafting point per 50 ethylene oxide units.

### Builders

The compositions may comprise a builder. Compositions typically comprise at least about 1% builder, based on the total weight of the composition. Liquid detergent compositions may comprise up to about 10% builder, and in some examples up to about 8% builder, of the total weight of the composition.

Suitable builders include aluminosilicates (e.g., zeolite builders, such as zeolite A, zeolite P, and zeolite MAP), silicates, phosphates, such as polyphosphates (e.g., sodium tri-polyphosphate), especially sodium salts thereof; carbonates, bicarbonates, sesquicarbonates, and carbonate minerals other than sodium carbonate or sesquicarbonate; organic mono-, di-, tri-, and tetracarboxylates, especially water-soluble nonsurfactant carboxylates in acid, sodium, potassium or alkanolammonium salt form, as well as oligomeric or water-soluble low molecular weight polymer carboxylates including aliphatic and aromatic types; and phytic acid. Additional suitable builders may be selected from citric acid, lactic acid, fatty acid, polycarboxylate builders, for example, copolymers of acrylic acid, copolymers of acrylic acid and maleic acid, and copolymers of acrylic acid and/or maleic acid, and other suitable ethylenic monomers with various types of additional functionalities. Alternatively, the composition may be substantially free of builder.

### Structurant/Thickeners

Suitable structurants/thickeners include di-benzylidene polyol acetal derivative. The fluid detergent composition may comprise from about 0.01% to about 1% by weight of a dibenzylidene polyol acetal derivative (DBPA), or from about 0.05% to about 0.8%, or from about 0.1% to about 0.6%, or even from about 0.3% to about 0.5%. The DBPA derivative may comprise a dibenzylidene sorbitol acetal derivative (DBS).

Suitable structurants/thickeners also include bacterial cellulose. The fluid detergent composition may comprise from about 0.005% to about 1% by weight of a bacterial cellulose network. The term “bacterial cellulose” encompasses any type of cellulose produced via fermentation of a bacteria of the genus Acetobacter such as CELLULON® by CPKelco U.S. and includes materials referred to popularly as microfibrillated cellulose, reticulated bacterial cellulose, and the like.

Suitable structurants/thickeners also include coated bacterial cellulose. The bacterial cellulose may be at least partially coated with a polymeric thickener. The at least partially coated bacterial cellulose may comprise from about 0.1% to about 5%, or even from about 0.5% to about 3%, by weight of bacterial cellulose; and from about 10% to about 90% by weight of the polymeric thickener. Suitable bacterial cellulose may include the bacterial cellulose described above and suitable polymeric thickeners include: carboxymethylcellulose, cationic hydroxymethylcellulose, and mixtures thereof.

Suitable structurants/thickeners also include cellulose fibers. The composition may comprise from about 0.01 to about 5% by weight of the composition of a cellulosic fiber. The cellulosic fiber may be extracted from vegetables, fruits or wood. Commercially available examples are Avicel® from FMC, Citri-Fi from Fiberstar or Betafib from Cosun.

Suitable structurants/thickeners also include non-polymeric crystalline hydroxyl-functional materials. The composition may comprise from about 0.01 to about 1% by weight of the composition of a non-polymeric crystalline, hydroxyl functional structurant. The non-polymeric crystalline, hydroxyl functional structurants generally may comprise a crystallizable glyceride which can be pre-emulsified to aid dispersion into the final fluid detergent composition. The crystallizable glycerides may include hydrogenated castor oil or “HCO” or derivatives thereof, provided that it is capable of crystallizing in the liquid detergent composition.

Suitable structurants/thickeners also include polymeric structuring agents. The compositions may comprise from about 0.01% to about 5% by weight of a naturally derived and/or synthetic polymeric structurant. Examples of naturally derived polymeric structurants of use in the present invention include: hydroxyethyl cellulose, hydrophobically modified hydroxyethyl cellulose, carboxymethyl cellulose, polysaccharide derivatives and mixtures thereof. Suitable polysaccharide derivatives include: pectine, alginate, arabinogalactan (gum Arabic), carrageenan, gellan gum, xanthan gum, guar gum and mixtures thereof. Examples of synthetic polymeric structurants of use in the present invention include: polycarboxylates, polyacrylates, hydrophobically modified ethoxylated urethanes, hydrophobically modified non-ionic polyols and mixtures thereof.

Suitable structurants/thickeners also include di-amido-gellants. The external structuring system may comprise a di-amido gellant having a molecular weight from about 150 g/mol to about 1,500 g/mol, or even from about 500 g/mol to about 900 g/mol. Such di-amido gellants may comprise at least two nitrogen atoms, wherein at least two of said nitrogen atoms form amido functional substitution groups. The amido groups may be different or the same. Non-limiting examples of di-amido gellants are: N,N′-(2S,2′S)-1,1′-(dodecane-1,12-diylbis(azanediyl))bis(3-methyl-1-oxobutane-2,1-diyl)diisonicotinamide; dibenzyl (2S,2′S)-1,1′-(propane-1,3-diylbis(azanediyl))bis(3-methyl-1-oxobutane-2,1-diyl)dicarbamate; dibenzyl (2S,2′S)-1,1′-(dodecane-1,12-diylbis(azanediyl))bis(1-oxo-3-phenylpropane-2,1-diyl)dicarbamate.

### Polymeric Dispersing Agents

The cleaning composition may comprise one or more polymeric dispersing agents. Examples are carboxymethylcellulose, poly(vinyl-pyrrolidone), poly (ethylene glycol), poly(vinyl alcohol), poly(vinylpyridine-N-oxide), poly(vinylimidazole), polycarboxylates such as polyacrylates, maleic/acrylic acid copolymers and lauryl methacrylate/acrylic acid co-polymers.

The cleaning composition may comprise one or more amphiphilic cleaning polymers such as the compound having the following general structure: bis((C₂H₅O)(C₂H₄O)n)(CH₃)—N⁺—CₓH₂ₓ—N⁺—(CH₃)-bis((C₂H₅O)(C₂H₄O)n), wherein n=from 20 to 30, and x=from 3 to 8, or sulphated or sulphonated variants thereof.

The cleaning composition may comprise amphiphilic alkoxylated grease cleaning polymers which have balanced hydrophilic and hydrophobic properties such that they remove grease particles from fabrics and surfaces. The amphiphilic alkoxylated grease cleaning polymers may comprise a core structure and a plurality of alkoxylate groups attached to that core structure. These may comprise alkoxylated polyalkylenimines, for example, having an inner polyethylene oxide block and an outer polypropylene oxide block. Such compounds may include, but are not limited to, ethoxylated polyethyleneimine, ethoxylated hexamethylene diamine, and sulfated versions thereof. Polypropoxylated derivatives may also be included. A wide variety of amines and polyalklyeneimines can be alkoxylated to various degrees. A useful example is 600 g/mol polyethyleneimine core ethoxylated to 20 EO groups per NH and is available from BASF. The detergent compositions described herein may comprise from about 0.1% to about 10%, and in some examples, from about 0.1% to about 8%, and in other examples, from about 0.1% to about 6%, by weight of the detergent composition, of alkoxylated polyamines.

Carboxylate polymer—The detergent composition may also include one or more carboxylate polymers, which may optionally be sulfonated. Suitable carboxylate polymers include a maleate/acrylate random copolymer or a poly(meth)acrylate homopolymer. In one aspect, the carboxylate polymer is a poly(meth)acrylate homopolymer having a molecular weight from 4,000 Da to 9,000 Da, or from 6,000 Da to 9,000 Da.

Alkoxylated polycarboxylates may also be used in the detergent compositions herein to provide grease removal. Such materials are described in WO 91/08281 and PCT 90/01815. Chemically, these materials comprise poly(meth)acrylates having one ethoxy side-chain per every 7-8 (meth)acrylate units. The side-chains are of the formula —(CH₂CH₂O)ₘ(CH₂)ₙCH₃ wherein m is 2-3 and n is 6-12. The side-chains are ester-linked to the polyacrylate “backbone” to provide a “comb” polymer type structure. The molecular weight can vary, but may be in the range of about 2000 to about 50,000. The detergent compositions described herein may comprise from about 0.1% to about 10%, and in some examples, from about 0.25% to about 5%, and in other examples, from about 0.3% to about 2%, by weight of the detergent composition, of alkoxylated polycarboxylates.

### Soil Release Polymer

Suitable copolymers may include a structure as defined by the combination of structural units (I), (II), (III), (IV) such as, for example, a combination of one or more of (I) and (IV), a combination of one or more of (II) and (IV), a combination of one or more of (III) and (IV), a combination of one or more of (I), (II), and (IV), a combination of one or more of (II), (III), and (IV), a combination of one or more of (I) and (II), or a plurality of any of (I), (II), (III) or (IV), a combination of one or more of (I), (II), (III) and (IV), a combination of one or more of (I) and (II), or a plurality of any of (I), (II), (III) or (IV):

—[(OCHR¹—CHR²)ₐ—O—OC—Ar—CO—]_{d} (I)

—[(OCHR³—X—CHR⁴)_{b}—O—OC—Ar—CO—]ₑ (II)

—[(OCHR³—CHR⁴)_{b}—O—OC-sAr—CO—]ₑ (III)

—[(OCHR⁵—CHR⁶)_{c}—OR⁷]_{f} (IV)

wherein:

a, b and c are from 1 to 200;

d, e and f are from 1 to 50;

Ar is a 1,4-substituted phenylene;

sAr is 1,3-substituted phenylene substituted in position 5 with SO₃M;

M is a counterion selected from Na, Li, K, Mg/2, Ca/2, Al/3, ammonium, mono-, di-, tri-, or tetraalkylammonium wherein the alkyl groups are C₁-C₁₈ alkyl or C₂-C₁₀ hydroxyalkyl, or mixtures thereof;

X is a bifunctional group containing at least one carbon atom and at least one hydroxyl unit or at least one amine unit;

R¹, R², R³, R⁴, R⁵ and R⁶ are independently selected from H or C₁-C₁₈ n- or iso-alkyl; and

R⁷ is a linear or branched C₁-C₁₈ alkyl, or a linear or branched C₂-C₃₀ alkenyl, or a cycloalkyl group with 5 to 9 carbon atoms, or a C₈-C₃₀ aryl group, or a C₆-C₃₀ arylalkyl group.

The polyester terephthalates according to the invention generally have a number average molecular weight in the range of 700 to 50000 g/mol, preferably 800 to 25000 g/mol, more preferably 1000 to 15000 g/mol, most preferably 1200 to 12000 g/mol.

Examples of suitable polyester soil release polymers are the TexCare® polymers, including TexCare® SRA-100, SRA-300, SRN-100, SRN-170, SRN-240, SRN-260, SRN-300, and SRN-325, supplied by Clariant. Other suitable soil release polymers are Marloquest® polymers, such as Marloquest® SL, HSCB, L235M B, and G82, supplied by Sasol. Other suitable polyester soil release polymers are the REPEL-O-TEX® line of polymers supplied by Rhodia, including REPEL-O-TEX® SF, SF-2, and SRP6.

### Cellulosic Polymer

The cleaning compositions of the present invention may also include one or more cellulosic polymers including those selected from alkyl cellulose, alkyl alkoxyalkyl cellulose, carboxyalkyl cellulose, alkyl carboxyalkyl cellulose. In one aspect, the cellulosic polymers are selected from the group comprising carboxymethyl cellulose, methyl cellulose, methyl hydroxyethyl cellulose, methyl carboxymethyl cellulose, and mixtures thereof. In one aspect, the carboxymethyl cellulose has a degree of carboxymethyl substitution from 0.5 to 0.9 and a molecular weight from 100,000 Da to 300,000 Da.

### Amines

Additional amines may be used in the compositions described herein for added removal of grease and particulates from soiled materials. The compositions described herein may comprise from about 0.1% to about 10%, or from about 0.1% to about 4%, or from about 0.1% to about 2%, by weight of the composition, of additional amines. Non-limiting examples of additional amines include, but are not limited to, polyetheramines, polyamines, oligoamines, triamines, diamines, pentamines, tetraamines, or combinations thereof. Specific examples of suitable additional amines include tetraethylenepentamine, triethylenetetraamine, diethylenetriamine, or a mixture thereof.

### Bleaching Agents

The detergent compositions of the present invention may comprise one or more bleaching agents. Suitable bleaching agents other than bleaching catalysts include photobleaches, bleach activators, hydrogen peroxide, sources of hydrogen peroxide, pre-formed peracids and mixtures thereof. In general, when a bleaching agent is used, the detergent compositions of the present invention may comprise from about 0.1% to about 50% or even from about 0.1% to about 25% bleaching agent by weight of the detergent composition.

### Bleach Catalysts

The detergent compositions of the present invention may also include one or more bleach catalysts capable of accepting an oxygen atom from a peroxyacid and/or salt thereof, and transferring the oxygen atom to an oxidizable substrate. Suitable bleach catalysts include, but are not limited to: iminium cations and polyions; iminium zwitterions; modified amines; modified amine oxides; N-sulphonyl imines; N-phosphonyl imines; N-acyl imines; thiadiazole dioxides; perfluoroimines; cyclic sugar ketones and mixtures thereof.

### Brighteners

Optical brighteners or other brightening or whitening agents may be incorporated at levels of from about 0.01% to about 1.2%, by weight of the composition, into the detergent compositions described herein. Commercial fluorescent brighteners suitable for the present invention can be classified into subgroups, including but not limited to: derivatives of stilbene, pyrazoline, coumarin, benzoxazoles, carboxylic acid, methinecyanines, dibenzothiophene-5,5-dioxide, azoles, 5- and 6-membered-ring heterocycles, and other miscellaneous agents. In some examples, the fluorescent brightener is selected from the group consisting of disodium 4,4′-bis{[4-anilino-6-morpholino-s-triazin-2-yl]-amino}-2,2′-stilbenedisulfonate (brightener 15, commercially available under the tradename Tinopal AMS-GX by Ciba Geigy Corporation), disodium4,4′-bis{[4-anilino-6-(N-2-bis-hydroxyethyl)-s-triazine-2-yl]-amino}-2,2′-stilbenedisulonate (commercially available under the tradename Tinopal UNPA-GX by Ciba-Geigy Corporation), disodium 4,4′-bis{[4-anilino-6-(N-2-hydroxyethyl-N-methylamino)-s-triazine-2-yl]-amino}-2,2′-stilbenedisulfonate (commercially available under the tradename Tinopal SBM-GX by Ciba-Geigy Corporation). More preferably, the fluorescent brightener is disodium 4,4′-bis{[4-anilino-6-morpholino-s-triazin-2-yl]-amino}-2,2′-stilbenedisulfonate.

The brighteners may be added in particulate form or as a premix with a suitable solvent, for example nonionic surfactant, propanediol.

### Fabric Hueing Agents

The composition may comprise a fabric hueing agent (sometimes referred to as shading, bluing or whitening agents). Typically the hueing agent provides a blue or violet shade to fabric. Hueing agents can be used either alone or in combination to create a specific shade of hueing and/or to shade different fabric types. This may be provided for example by mixing a red and green-blue dye to yield a blue or violet shade. Hueing agents may be selected from any known chemical class of dye, including but not limited to acridine, anthraquinone (including polycyclic quinones), azine, azo (e.g., monoazo, disazo, trisazo, tetrakisazo, polyazo), including premetallized azo, benzodifurane and benzodifuranone, carotenoid, coumarin, cyanine, diazahemicyanine, diphenylmethane, formazan, hemicyanine, indigoids, methane, naphthalimides, naphthoquinone, nitro and nitroso, oxazine, phthalocyanine, pyrazoles, stilbene, styryl, triarylmethane, triphenylmethane, xanthenes and mixtures thereof.

Suitable fabric hueing agents include dyes, dye-clay conjugates, and organic and inorganic pigments. Suitable dyes also include small molecule dyes and polymeric dyes. Suitable small molecule dyes include small molecule dyes selected from the group consisting of dyes falling into the Colour Index (C.I.) classifications of Direct, Basic, Reactive or hydrolysed Reactive, Solvent or Disperse dyes for example that are classified as Blue, Violet, Red, Green or Black, and provide the desired shade either alone or in combination. Suitable polymeric dyes include polymeric dyes selected from the group consisting of polymers containing covalently bound (sometimes referred to as conjugated) chromogens, (dye-polymer conjugates), for example polymers with chromogens co-polymerized into the backbone of the polymer and mixtures thereof. Suitable polymeric dyes also include polymeric dyes selected from the group consisting of fabric-substantive colorants sold under the name of Liquitint® (Milliken, Spartanburg, S.C., USA), dye-polymer conjugates formed from at least one reactive dye and a polymer selected from the group consisting of polymers comprising a moiety selected from the group consisting of a hydroxyl moiety, a primary amine moiety, a secondary amine moiety, a thiol moiety and mixtures thereof. Suitable polymeric dyes also include polymeric dyes selected from the group consisting of Liquitint® Violet CT, carboxymethyl cellulose (CMC) covalently bound to a reactive blue, reactive violet or reactive red dye such as CMC conjugated with C.I. Reactive Blue 19, sold by Megazyme, Wicklow, Ireland under the product name AZO-CM-CELLULOSE, product code S-ACMC, alkoxylated triphenyl-methane polymeric colourants, alkoxylated thiophene polymeric colourants, and mixtures thereof.

The aforementioned fabric hueing agents can be used in combination (any mixture of fabric hueing agents can be used).

### Encapsulates

The compositions may comprise an encapsulate. The encapsulate may comprise a core, a shell having an inner and outer surface, where the shell encapsulates the core.

The encapsulate may comprise a core and a shell, where the core comprises a material selected from perfumes; brighteners; dyes; insect repellants; silicones; waxes; flavors; vitamins; fabric softening agents; skin care agents, e.g., paraffins; enzymes; anti-bacterial agents; bleaches; sensates; or mixtures thereof; and where the shell comprises a material selected from polyethylenes; polyamides; polyvinylalcohols, optionally containing other co-monomers; polystyrenes; polyisoprenes; polycarbonates; polyesters; polyacrylates; polyolefins; polysaccharides, e.g., alginate and/or chitosan; gelatin; shellac; epoxy resins; vinyl polymers; water insoluble inorganics; silicone; aminoplasts, or mixtures thereof. When the shell comprises an aminoplast, the aminoplast may comprise polyurea, polyurethane, and/or polyureaurethane. The polyurea may comprise polyoxymethyleneurea and/or melamine formaldehyde.

The encapsulate may comprise a core, and the core may comprise a perfume. The encapsulate may comprise a shell, and the shell may comprise melamine formaldehyde and/or cross linked melamine formaldehyde. The encapsulate may comprise a core comprising a perfume and a shell comprising melamine formaldehyde and/or cross linked melamine formaldehyde

Suitable encapsulates may comprise a core material and a shell, where the shell at least partially surrounds the core material. The core of the encapsulate comprises a material selected from a perfume raw material and/or optionally another material, e.g., vegetable oil, esters of vegetable oils, esters, straight or branched chain hydrocarbons, partially hydrogenated terphenyls, dialkyl phthalates, alkyl biphenyls, alkylated naphthalene, petroleum spirits, aromatic solvents, silicone oils, or mixtures thereof.

The wall of the encapsulate may comprise a suitable resin, such as the reaction product of an aldehyde and an amine. Suitable aldehydes include formaldehyde. Suitable amines include melamine, urea, benzoguanamine, glycoluril, or mixtures thereof. Suitable melamines include methylol melamine, methylated methylol melamine, imino melamine and mixtures thereof. Suitable ureas include, dimethylol urea, methylated dimethylol urea, urea-resorcinol, or mixtures thereof.

Suitable formaldehyde scavengers may be employed with the encapsulates, for example, in a capsule slurry and/or added to a composition before, during, or after the encapsulates are added to such composition.

Suitable capsules can be purchased from Encapsys Inc. of Appleton, Wis. USA.

### Perfumes

Perfumes and perfumery ingredients may be used in the detergent compositions described herein. Non-limiting examples of perfume and perfumery ingredients include, but are not limited to, aldehydes, ketones, esters, and the like. Other examples include various natural extracts and essences which can comprise complex mixtures of ingredients, such as orange oil, lemon oil, rose extract, lavender, musk, patchouli, balsamic essence, sandalwood oil, pine oil, cedar, and the like. Finished perfumes can comprise extremely complex mixtures of such ingredients. Finished perfumes may be included at a concentration ranging from about 0.01% to about 2% by weight of the detergent composition.

### Dye Transfer Inhibiting Agents

Fabric detergent compositions may also include one or more materials effective for inhibiting the transfer of dyes from one fabric to another during the cleaning process. Generally, such dye transfer inhibiting agents may include polyvinyl pyrrolidone polymers, polyamine N-oxide polymers, copolymers of N-vinylpyrrolidone and N-vinylimidazole, manganese phthalocyanine, peroxidases, and mixtures thereof. If used, these agents may be used at a concentration of about 0.0001% to about 10%, by weight of the composition, in some examples, from about 0.01% to about 5%, by weight of the composition, and in other examples, from about 0.05% to about 2% by weight of the composition.

### Chelating Agents

The detergent compositions described herein may also contain one or more metal ion chelating agents. Suitable molecules include copper, iron and/or manganese chelating agents and mixtures thereof. Such chelating agents can be selected from the group consisting of phosphonates, amino carboxylates, amino phosphonates, succinates, polyfunctionally-substituted aromatic chelating agents, 2-pyridinol-N-oxide compounds, hydroxamic acids, carboxymethyl insulins and mixtures thereof. Chelating agents can be present in the acid or salt form including alkali metal, ammonium, and substituted ammonium salts thereof, and mixtures thereof. Other suitable chelating agents for use herein are the commercial DEQUEST series, and chelants from Monsanto, Akzo-Nobel, DuPont, Dow, the Trilon® series from BASF and Nalco.

The chelant may be present in the detergent compositions disclosed herein at from about 0.005% to about 15% by weight, about 0.01% to about 5% by weight, about 0.1% to about 3.0% by weight, or from about 0.2% to about 0.7% by weight, or from about 0.3% to about 0.6% by weight of the detergent compositions disclosed herein.

### Suds Suppressors

Compounds for reducing or suppressing the formation of suds can be incorporated into the detergent compositions described herein. Suds suppression can be of particular importance in the so-called “high concentration cleaning process” and in front-loading style washing machines. The detergent compositions herein may comprise from 0.1% to about 10%, by weight of the composition, of suds suppressor.

Examples of suds supressors include monocarboxylic fatty acid and soluble salts therein, high molecular weight hydrocarbons such as paraffin, fatty acid esters (e.g., fatty acid triglycerides), fatty acid esters of monovalent alcohols, aliphatic C₁₈-C₄₀ ketones (e.g., stearone), N-alkylated amino triazines, waxy hydrocarbons preferably having a melting point below about 100° C., silicone suds suppressors, and secondary alcohols.

Additional suitable antifoams are those derived from phenylpropylmethyl substituted polysiloxanes.

The detergent composition may comprise a suds suppressor selected from organomodified silicone polymers with aryl or alkylaryl substituents combined with silicone resin and a primary filler, which is modified silica. The detergent compositions may comprise from about 0.001% to about 4.0%, by weight of the composition, of such a suds suppressor.

The detergent composition comprises a suds suppressor selected from: a) mixtures of from about 80 to about 92% ethylmethyl, methyl(2-phenylpropyl) siloxane; from about 5 to about 14% MQ resin in octyl stearate; and from about 3 to about 7% modified silica; b) mixtures of from about 78 to about 92% ethylmethyl, methyl(2-phenylpropyl) siloxane; from about 3 to about 10% MQ resin in octyl stearate; from about 4 to about 12% modified silica; or c) mixtures thereof, where the percentages are by weight of the anti-foam.

### Conditioning Agents

The composition of the present invention may include a high melting point fatty compound. The high melting point fatty compound useful herein has a melting point of 25° C. or higher, and is selected from the group consisting of fatty alcohols, fatty acids, fatty alcohol derivatives, fatty acid derivatives, and mixtures thereof. Such compounds of low melting point are not intended to be included in this section. The high melting point fatty compound is included in the composition at a level of from about 0.1% to about 40%, preferably from about 1% to about 30%, more preferably from about 1.5% to about 16% by weight of the composition, from about 1.5% to about 8%.

The composition of the present invention may include a nonionic polymer as a conditioning agent.

Suitable conditioning agents for use in the composition include those conditioning agents characterized generally as silicones (e.g., silicone oils, cationic silicones, silicone gums, high refractive silicones, and silicone resins), organic conditioning oils (e.g., hydrocarbon oils, polyolefins, and fatty esters) or combinations thereof, or those conditioning agents which otherwise form liquid, dispersed particles in the aqueous surfactant matrix herein. The concentration of the silicone conditioning agent typically ranges from about 0.01% to about 10%.

The compositions of the present invention may also comprise from about 0.05% to about 3% of at least one organic conditioning oil as the conditioning agent, either alone or in combination with other conditioning agents, such as the silicones (described herein). Suitable conditioning oils include hydrocarbon oils, polyolefins, and fatty esters.

### Fabric Enhancement Polymers

Suitable fabric enhancement polymers are typically cationically charged and/or have a high molecular weight. Suitable concentrations of this component are in the range from 0.01% to 50%, preferably from 0.1% to 15%, more preferably from 0.2% to 5.0%, and most preferably from 0.5% to 3.0% by weight of the composition. The fabric enhancement polymers may be a homopolymer or be formed from two or more types of monomers. The monomer weight of the polymer will generally be between 5,000 and 10,000,000, typically at least 10,000 and preferably in the range 100,000 to 2,000,000. Preferred fabric enhancement polymers will have cationic charge densities of at least 0.2 meq/g, preferably at least 0.25 meq/g, more preferably at least 0.3 meq/g, but also preferably less than 5 meq/g, more preferably less than 3 meq/g, and most preferably less than 2 meq/g at the pH of intended use of the composition, which pH will generally range from pH 3 to pH 9, preferably between pH 4 and pH 8. The fabric enhancement polymers may be of natural or synthetic origin.

### Pearlescent Agent

The laundry detergent compositions of the invention may comprise a pearlescent agent. Non-limiting examples of pearlescent agents include: mica; titanium dioxide coated mica; bismuth oxychloride; fish scales; mono and diesters of alkylene glycol. The pearlescent agent may be ethyleneglycoldistearate (EGDS).

### Antioxidant

The compositions of the present disclosure may include an antioxidant. Without wishing to be bound by theory, it is believed that antioxidants may help to improve malodor control and/or cleaning performance of the compositions, particularly in combination with the oligoamines of the present disclosure. Antioxidants may also help to reduce yellowing that may be associated with amines, allowing the amines to be formulated at a relatively higher level. Antioxidants are substances as described in Kirk-Othmer (Vol. 3, page 424) and in Ullmann's Encyclopedia (Vol. 3, page 91).

The compositions of the present disclosure may include an antioxidant, preferably a hindered phenol antioxidant, in an amount of from about 0.001% to about 2%, preferably from about 0.01% to about 0.5%, by weight of the composition.

Suitable antioxidants may include alkylated phenols, having the general formula:

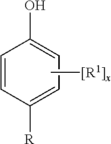

wherein R is C₁-C₂₂ linear alkyl or C₃-C₂₂ branched alkyl, each (1) having optionally therein one or more ester (—CO₂—) or ether (—O—) links, and (2) optionally substituted by an organic group comprising an alkyleneoxy or polyalkyleneoxy group selected from EO (ethoxy), PO (propoxy), BO (butoxy), and mixtures thereof, more preferably from EO alone or from EO/PO mixtures; R may preferably be methyl, branched C₃-C₆ alkyl, or C₁-C₆ alkoxy, preferably methoxy; R¹ is a C₃-C₆ branched alkyl, preferably tert-butyl; x is 1 or 2.

Preferred types of alkylated phenols having this formula may include hindered phenolic compounds. As used herein, the term “hindered phenol” is used to refer to a compound comprising a phenol group with either (a) at least one C₃ or higher branched alkyl, preferably a C₃-C₆ branched alkyl, preferably tert-butyl, attached at a position ortho to at least one phenolic —OH group, or (b) substituents independently selected from the group consisting of a C₁-C₆ alkoxy, preferably methoxy, a C₁-C₂₂ linear alkyl or C₃-C₂₂ branched alkyl, preferably methyl or branched C₃-C₆ alkyl, or mixtures thereof, at each position ortho to at least one phenolic —OH group. If a phenyl ring comprises more than one —OH group, the compound is a hindered phenol provided at least one such —OH group is substituted as described immediately above. Where any R group in the structure above comprises three or more contiguous monomers, that antioxidant is defined herein as a “polymeric hindered phenol antioxidant.” Compositions according to the present disclosure may include a hindered phenol antioxidant. A preferred hindered phenol antioxidant includes 3,5-di-tert-butyl-4-hydroxytoluene (BHT).

A further class of hindered phenol antioxidants that may be suitable for use in the composition is a benzofuran or benzopyran derivative having the formula:

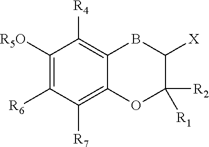

wherein R₁ and R₂ are each independently alkyl or R₁ and R₂ can be taken together to form a C₅-C₆ cyclic hydrocarbyl moiety; B is absent or CH₂; R₄ is C₁-C₆ alkyl; R₅ is hydrogen or —C(O)R₃ wherein R₃ is hydrogen or C₁-C₁₉ alkyl; R₆ is C₁-C₆ alkyl; R₇ is hydrogen or C₁-C₆ alkyl; X is —CH₂OH, or —CH₂A wherein A is a nitrogen-comprising unit, phenyl, or substituted phenyl. Preferred nitrogen-comprising A units include amino, pyrrolidino, piperidino, morpholino, piperazino, and mixtures thereof.

Suitable hindered phenol antioxidants may include: 2,6-bis(1,1-dimethylethyl)-4-methyl-phenol; 3,5-bis(1,1-dimethylethyl)-4-hydroxy-benzenepropanoic acid, methyl ester; 3,5-bis(1,1-dimethylethyl)-4-hydroxybenzenepropanoic acid, octadecyl ester; or mixtures thereof.

Commercially available antioxidants that may be suitable include BHT, RALOX 35™, and/or TINOGARD TS™.

Additional antioxidants may be employed. Examples of suitable antioxidants for use in the composition include, but are not limited to, the group consisting of α-, β-, γ-, δ-tocopherol, ethoxyquin, 2,2,4-trimethyl-1,2-dihydroquinoline, 2,6-di-tert-butyl hydroquinone, tert-butyl hydroxyanisole, lignosulphonic acid and salts thereof, and mixtures thereof. It is noted that ethoxyquin (1,2-dihydro-6-ethoxy-2,2,4-trimethylquinoline) is marketed under the name Raluquin™ by the company Raschig™. Other types of antioxidants that may be used in the composition are 6-hydroxy-2,5,7,8-tetramethylchroman-2-carboxylic acid (Trolox™) and 1,2-benzisothiazoline-3-one (Proxel GXL™). Antioxidants such as tocopherol sorbate, butylated hydroxyl benzoic acids and their salts, gallic acid and its alkyl esters, uric acid and its salts, sorbic acid and its salts, and dihydroxyfumaric acid and its salts may also be useful. Other useful antioxidants may include tannins, such as tannins selected from the group consisting of gallotannins, ellagitannins, complex tannins, condensed tannins, and combinations thereof.

The use of non-yellowing antioxidants, such as non-yellowing hindered phenol antioxidants, may be preferred. Antioxidants that form such yellow by-products may be avoided if they lead to perceptible negative attributes in the consumer experience (such as deposition of yellow by-products on fabric, for example). The skilled artisan is able to make informed decisions regarding the selection of antioxidants to employ.

### Malodour Reduction Agent

Suitable oligoamines for malodour reduction on fabric may include diethylenetriamine (DETA), 4-methyl diethylenetriamine (4-MeDETA), dipropylenetriamine (DPTA), 5-methyl dipropylenetriamine (5-MeDPTA), triethylenetetraamine (TETA), 4-methyl triethylenetetraamine (4-MeTETA), 4,7-dimethyl triethylenetetraamine (4,7-Me₂TETA), 1,1,4,7,7-pentamethyl diethylenetriamine (M5-DETA), tripropylenetetraamine (TPTA), tetraethylenepentaamine (TEPA), tetrapropylenepentaamine (TPPA), pentaethylenehexaamine (PEHA), pentapropylenehexaamine (PPHA), hexaethyleneheptaamine (HEHA), hexapropyleneheptaamine (HPHA), N,N′-Bis(3-aminopropyl)ethylenediamine, or mixtures thereof.

The oligoamine may preferably be selected from diethylenetriamine (DETA), 4-methyl diethylenetriamine (4-MeDETA), 1,1,4,7,7-pentamethyl diethylenetriamine (M5-DETA), dipropylenetriamine (DPTA), 5-methyl dipropylenetriamine (5-MeDPTA), triethylenetetramine (TETA), tripropylenetetraamine (TPTA), tetraethylenepentaamine (TEPA), tetrapropylenepentaamine (TPTA), N,N′-Bis(3-aminopropyl)ethylenedi amine, and mixtures thereof, more preferably diethylenetriamine (DETA), 4-methyl diethylenetriamine (4-MeDETA), 1,1,4,7,7-pentamethyl diethylenetriamine (M5-DETA), triethylenetetramine (TETA), tetraethylenepentaamine (TEPA), N,N′-Bis(3-aminopropyl)ethylenediamine, and mixtures thereof, even more preferably diethylenetriamine (DETA), 4-methyl diethylenetriamine (4-MeDETA), N,N′-Bis(3-aminopropyl)ethylenediamine, and mixtures thereof, most preferably diethylenetriamine (DETA). DETA may be preferred due to its low molecular weight and/or relatively low cost to produce.

### Buffer System

The detergent compositions described herein may be formulated such that, during use in aqueous cleaning operations, the wash water will have a pH of between about 7.0 and about 12, and in some examples, between about 7.0 and about 11. Techniques for controlling pH at recommended usage levels include the use of buffers, alkalis, or acids, and are well known to those skilled in the art. These include, but are not limited to, the use of sodium carbonate, citric acid or sodium citrate, lactic acid or lactate, monoethanol amine or other amines, boric acid or borates, and other pH-adjusting compounds well known in the art.

The detergent compositions herein may comprise dynamic in-wash pH profiles. Such detergent compositions may use wax-covered citric acid particles in conjunction with other pH control agents such that (i) about 3 minutes after contact with water, the pH of the wash liquor is greater than 10; (ii) about 10 minutes after contact with water, the pH of the wash liquor is less than 9.5; (iii) about 20 minutes after contact with water, the pH of the wash liquor is less than 9.0; and (iv) optionally, wherein, the equilibrium pH of the wash liquor is in the range of from about 7.0 to about 8.5.

### Water-Soluble Film

The compositions of the present disclosure may be encapsulated within a water-soluble film, for example, a film comprising polyvinyl alcohol (PVOH).

### Other Adjunct Ingredients

A wide variety of other ingredients may be used in the detergent compositions herein, including other active ingredients, carriers, hydrotropes, processing aids, dyes or pigments, solvents for liquid formulations, and solid or other liquid fillers, erythrosine, colliodal silica, waxes, probiotics, surfactin, aminocellulosic polymers, Zinc Ricinoleate, perfume microcapsules, rhamnolipids, sophorolipids, glycopeptides, methyl ester sulfonates, methyl ester ethoxylates, sulfonated estolides, cleavable surfactants, biopolymers, silicones, modified silicones, aminosilicones, deposition aids, locust bean gum, cationic hydroxyethylcellulose polymers, cationic guars, hydrotropes (especially cumenesulfonate salts, toluenesulfonate salts, xylenesulfonate salts, and naphtalene salts), antioxidants, BHT, PVA particle-encapsulated dyes or perfumes, pearlescent agents, effervescent agents, color change systems, silicone polyurethanes, opacifiers, tablet disintegrants, biomass fillers, fast-dry silicones, glycol distearate, hydroxyethylcellulose polymers, hydrophobically modified cellulose polymers or hydroxyethylcellulose polymers, starch perfume encapsulates, emulsified oils, bisphenol antioxidants, microfibrous cellulose structurants, properfumes, styrene/acrylate polymers, triazines, soaps, superoxide dismutase, benzophenone protease inhibitors, functionalized TiO2, dibutyl phosphate, silica perfume capsules, and other adjunct ingredients, silicate salts (e.g., sodium silicate, potassium silicate), choline oxidase, pectate lyase, mica, titanium dioxide coated mica, bismuth oxychloride, and other actives.

The compositions described herein may also contain vitamins and amino acids such as: water soluble vitamins and their derivatives, water soluble amino acids and their salts and/or derivatives, water insoluble amino acids viscosity modifiers, dyes, nonvolatile solvents or diluents (water soluble and insoluble), pearlescent aids, foam boosters, additional surfactants or nonionic cosurfactants, pediculocides, pH adjusting agents, perfumes, preservatives, chelants, proteins, skin active agents, sunscreens, UV absorbers, vitamins, niacinamide, caffeine, and minoxidil.

The compositions of the present invention may also contain pigment materials such as nitroso, monoazo, disazo, carotenoid, triphenyl methane, triaryl methane, xanthene, quinoline, oxazine, azine, anthraquinone, indigoid, thionindigoid, quinacridone, phthalocianine, botanical, and natural colors, including water soluble components such as those having C.I. Names. The detergent compositions of the present invention may also contain antimicrobial agents.

### Water

The compositions disclosed herein may comprise from about 1% to about 80%, by weight of the composition, water. When the composition is a heavy duty liquid detergent composition, the composition typically comprises from about 40% to about 80% water. When the composition is a compact liquid detergent, the composition typically comprises from about 20% to about 60%, or from about 30% to about 50% water. When the composition is in unit dose form, for example, encapsulated in water-soluble film, the composition typically comprises less than 20%, or less than 15%, or less than 12%, or less than 10%, or less than 8%, or less than 5% water.

### Methods of Use

The present invention includes methods for cleaning soiled material. Compact fluid detergent compositions that are suitable for sale to consumers are suited for use in laundry pretreatment applications, laundry cleaning applications, and home care applications.

Such methods include, but are not limited to, the steps of contacting detergent compositions in neat form or diluted in wash liquor, with at least a portion of a soiled material and then optionally rinsing the soiled material. The soiled material may be subjected to a washing step prior to the optional rinsing step.

For use in laundry pretreatment applications, the method may include contacting the detergent compositions described herein with soiled fabric. Following pretreatment, the soiled fabric may be laundered in a washing machine or otherwise rinsed.

Machine laundry methods may comprise treating soiled laundry with an aqueous wash solution in a washing machine having dissolved or dispensed therein an effective amount of a machine laundry detergent composition in accord with the invention. An “effective amount” of the detergent composition means from about 20 g to about 300 g of product dissolved or dispersed in a wash solution of volume from about 5 L to about 65 L. The water temperatures may range from about 5° C. to about 100° C. The water to soiled material (e.g., fabric) ratio may be from about 1:1 to about 30:1. The compositions may be employed at concentrations of from about 500 ppm to about 15,000 ppm in solution. In the context of a fabric laundry composition, usage levels may also vary depending not only on the type and severity of the soils and stains, but also on the wash water temperature, the volume of wash water, and the type of washing machine (e.g., top-loading, front-loading, top-loading, vertical-axis Japanese-type automatic washing machine).

The detergent compositions herein may be used for laundering of fabrics at reduced wash temperatures. These methods of laundering fabric comprise the steps of delivering a laundry detergent composition to water to form a wash liquor and adding a laundering fabric to said wash liquor, wherein the wash liquor has a temperature of from about 0° C. to about 20° C., or from about 0° C. to about 15° C., or from about 0° C. to about 9° C. The fabric may be contacted to the water prior to, or after, or simultaneous with, contacting the laundry detergent composition with water.

Another method includes contacting a nonwoven substrate, which is impregnated with the detergent composition, with a soiled material. As used herein, “nonwoven substrate” can comprise any conventionally fashioned nonwoven sheet or web having suitable basis weight, caliper (thickness), absorbency, and strength characteristics. Non-limiting examples of suitable commercially available nonwoven substrates include those marketed under the tradenames SONTARA® by DuPont and POLYWEB® by James River Corp.

Hand washing/soak methods, and combined handwashing with semi-automatic washing machines, are also included.

### Packaging for the Compositions

The compact fluid detergent compositions that are suitable for consumer use can be packaged in any suitable container including those constructed from paper, cardboard, plastic materials, and any suitable laminates. The compact fluid detergent compositions may also be encapsulated in water-soluble film and packaged as a unitized dose detergent composition, for example, mono-compartment pouches or multi-compartment pouches having superposed and/or side-by-side compartments.

### EXAMPLES

In the following examples, the individual ingredients within the cleaning compositions are expressed as percentages by weight of the cleaning compositions.

### Example 1. Liquid or Gel Detergents

Table 1 shows illustrative liquid or gel detergent fabric care compositions that may be prepared by mixing the ingredients listed in the proportions shown below. Graft copolymer, mannanase and cellulase enzymes, xyloglucanase and endolase, are added as described in the specific examples below.

TABLE 1

| Ingredient (wt %) | 1A | 1B | 1C | 1D | 1E |
|---|---|---|---|---|---|
| C₁₂-C₁₅ alkyl polyethoxylate (3.0 or | 3.0 | 3.0 | 3.0 | 5.5 | 4.1 |
| 1.8) sulfate¹ | | | | | |
| C_{11.8} linear alkylbenzene sulfonic | 7.4 | 7.4 | 7.4 | 12.5 | 15.2 |
| acid² | | | | | |
| C₁₄-C₁₅ alkyl 7-ethoxylate¹ | 2.9 | 2.9 | 2.9 | 5.2 | 3.9 |
| or C₁₂-C₁₄ alkyl 7-ethoxylate³ | | | | | |
| (or mixtures thereof) | | | | | |
| C₁₂-C₁₄ amine oxide | 0.4 | 0.4 | 0.4 | 0.5 | 0.5 |
| C₁₂-C₁₈ Fatty Acid⁴ | 1.3 | 1.3 | 2.6 | 1.6 | 1.5 |
| 1,2 Propane diol⁵ | 0.6 | 0.6 | 1.2 | 4.5 | 4.5 |
| Na Cumene Sulfonate | 1.3 | 1.3 | 1.3 | — | — |
| Citric acid | 2.8 | 2.8 | 2.8 | 5.9 | 5.9 |
| Enzymes (mixtures of protease⁶ and | 0.034 | 0.064 | 0.004 | 0.088 | 0.088 |
| (amylase, lipase, pectawash)⁷ | | | | | |
| Enzymes of the present invention | From 0.0001% to 2% further described in the examples below | | | | |
| (mannanse, xyloglucanase, | | | | | |
| endolase)⁷ | | | | | |
| Cleaning Polymer^{8, 9, 10} | 0.5 | 0.5 | 0.5 | 1.5 | 1.5 |
| Graft copolymer¹¹ | From 0.1% to 15% further described in the example below | | | | |
| Hydrogenated castor oil¹² | 0.3 | 0.3 | 0.3 | 0.1 | 0.1 |
| Water, solvents, perfumes, | to 100%; | to 100%; | to 100%; | to 100%; | to 100%; |
| encapsulated perfume, chelant, dyes, | pH 7.0-8.5 | pH 7.0-8.5 | pH 7.0-8.5 | pH 7.0-8.5 | pH 7.0-8.5 |
| brighteners, hue dyes, buffers, | | | | | |
| neutralizers, stabilizers, enzymes and | | | | | |
| other optional components | | | | | |

¹Available from Shell Chemicals, Houston, TX.
²Available from Huntsman Chemicals, Salt Lake City, UT.
³Available from Sasol Chemicals, Johannesburg, South Africa
⁴Available from The Procter & Gamble Company, Cincinnati, OH.
⁵Available from Sigma Aldrich chemicals, Milwaukee, WI
⁶Available from DuPont-Genencor, Palo Alto, CA.
⁷Available from Novozymes, Copenhagen,Denmark
⁸600 g/mol molecular weight polyethylenimine core with 20 ethoxylate groups per —NH and available from BASF (Ludwigshafen, Germany)
⁹600 g/mol molecular weight polyethylenimine core with 24 ethoxylate groups per —NH and 16 propoxylate groups per —NH. Available from BASF (Ludwigshafen, Germany)
¹⁰Described in U.S. Pat. No. 8,143,209 and available from BASF (Ludwigshafen, Germany)
¹¹Described in WO 01/05874 and available from BASF (Ludwigshafen, Germany) or in the specification herein.
¹²Available under the tradename ThixinR from Elementis Specialties, Highstown, NJ

### Example 2. Liquid Detergents in the Form of Soluble Mono- or Multi-Compartment Unit Dose

The following compositions were prepared by mixing of the individual components in the proportions shown below, followed by enclosing in a water soluble poly(vinyl alcohol) film supplied by the Monosol company, to obtain water soluble unit dose laundry pouches. Each unit dose laundry pouch comprised 29.9 g of the detergent compositions. Graft copolymer, mannanase and cellulase enzymes, xyloglucanase and endolase, are added as described in the specific examples below.

TABLE 2

| Ingredient (wt %) | 2A | 2B | 2C | 2D | 2E |
|---|---|---|---|---|---|
| C₁₂-C₁₅ alkyl polyethoxylate | 15.5 | 8.8 | 9.5 | 13.7 | 10.3 |
| (3.0) sulfate¹ | | | | | |
| C_{11.8} linear alkylbenzene | 22.8 | 18.6 | 20.1 | 13.7 | 20.9 |
| sulfonic acid² | | | | | |
| C₁₄-C₁₅ alkyl 7-ethoxylate¹ | 3.9 | 14.5 | 17.1 | 14.5 | 9.8 |
| or C₁₂-C₁₄ alkyl 7-ethoxylate³ | | | | | |
| (or mixtures thereof) | | | | | |
| 1,2 Propane diol⁵ | 11.9 | 15.0 | 15.7 | 15.7 | 15.7 |
| Glycerol | 4.0 | 5.0 | 5.4 | 4.9 | 4.0 |
| Di propylene Glycol | 4.2 | 4.2 | 0.5 | 4.2 | 4.2 |
| C₁₂-C₁₈ Fatty Acid⁴ | 6.3 | 6.1 | 6.5 | 6.1 | 6.1 |
| Citric acid | 0.9 | 0.9 | 0.9 | 0.9 | 0.9 |
| Enzymes (mixtures of | 0.1 | 0.1 | 0.05 | 0.05 | 0.1 |
| Protease⁶ and (amylase, | | | | | |
| lipase, mannanase, | | | | | |
| xyloglucanase)⁷ | | | | | |
| Fluorescent Whitening | 0.2 | 0.2 | 0.2 | 0.2 | 0.32 |
| Agent⁸ | | | | | |
| Hueing Agent | 0.03 | 0.03 | 0.03 | 0.0 | 0.03 |
| Chelant | 0.9 | 2.1 | 0.9 | 0.9 | 0.9 |
| Cleaning Polymers^{10, 11} | 3.4 | 2.5 | 6.4 | 3.2 | 3.4 |
| Graft Copolymer¹² | From 0.1% to 15% | | | | |
| Hydrogenated castor oil¹³ | 0.1 | 0.13 | 0.15 | 0.15 | 0.15 |
| Water, perfumes, dyes, | to 100% | to 100% | to 100% | to 100% | to 100% |
| buffers, neutralizers, | pH 7.0-8.5 | pH 7.0-8.5 | pH 7.0-8.5 | pH 7.0-8.5 | pH 7.0-8.5 |
| stabilizers and other optional | | | | | |
| components | | | | | |

¹Available from Shell Chemicals, Houston, TX.
²Available from Huntsman Chemicals, Salt Lake City, UT.
³Available from Sasol Chemicals, Johannesburg, South Africa
⁴Available from The Procter & Gamble Company, Cincinnati, OH.
⁵Available from Sigma Aldrich chemicals, Milwaukee, WI
⁶Available from DuPont-Genencor, Palo Alto, CA.
⁷Available from Novozymes, Copenhagen, Denmark
⁸Available from Ciba Specialty Chemicals, High Point, NC
⁹Available from Milliken Chemical, Spartanburg, SC
¹⁰600 g/mol molecular weight polyethylenimine core with 20 ethoxylate groups per —NH and available from BASF (Ludwigshafen, Germany)
¹¹600 g/mol molecular weight polyethylenimine core with 24 ethoxylate groups per —NH and 16 propoxylate groups per —NH. Available from BASF (Ludwigshafen, Germany)
¹²Described in WO 01/05874 and available from BASF (Ludwigshafen, Germany) or in the specification herein.
¹³Available under the tradename ThixinR from Elementis Specialties, Highstown, NJ

### Example 3. Better Sebum Removal in Detergents with Mannanase and Cellulase Enzymes

Stain removal is an important aspect of detergents, and sebum stains are believed to be predictive of body soil stains in real item cleaning. The compositions of the present invention containing a combination of mannanse and at least one or more cellulase enzymes have superior sebum stain removal on PCS132 discriminating sebum. As can be seen from Table 3, adding cellulase enzymes, xyloglucanase (XYG) (3B) or the combination of XYG and endolase (3C) to the comparative example 3A results in sebum stain removal that is within the standard deviation, and therefore equivalent. Sebum stain removal is improved with mannanase (3E), however the combination of mannanase and xyloglucanse (3F), and the combination of mannanase and xyloglucanase and endolase (3H) results in even greater sebum stain removal with an improvement of 10 to 12 units. These improvements are surprising since XYG or a combination of XYG and endolase do not give any improvement in sebum removal versus the detergent comparative example (3B and 3C compared to 3A). Without being bound by theory, it is believed that the mannanase enzyme and cellulase enzyme create a synergy when removing sebum stains wherein the enzymes complement each other in a surprising manner to clean sebum at a level unattainable by each individual enzyme.

TABLE 3

| | | | PSC132 | |
|---|---|---|---|---|
| | | | Discriminating | Improvement vs |
| | Detergent | Enzymes Added to Detergent | Sebum | Comparative |
| Example | Example | Example | Stain Removal | Example |
| 3A | 1A | none | 45^{c} | Comparative |
| | | | | Example 3A |
| 3B | 1A | 0.01% XYG^{a} | 43^{c} | Equal to 3A |
| 3C | 1A | 0.01% XYG + 0.005% | 47^{c} | Equal to 3A |
| | | Endolase^{b} | | |
| 3D | 1B | none | 42^{d} | Comparative |
| | | | | Example 3D |
| 3E | 1B | 0.001% Mannanase | 49^{d} | +7 vs 3D |
| 3F | 1B | 0.01% XYG + 0.001% | 52^{d} | +10 vs 3D |
| | | Mannanase | | |
| 3G | 1A | none | 47 | Comparative |
| | | | | Example 3G |
| 3H | 1A | 0.01% XYG^{a} + 0.001% | 59 | +12 vs 3G |
| | | Mannanase + 0.005% Endolase^{b} | | |

^{a}Xyloglucanase (XYG) available under the tradename Whitezyme from Novozymes, Copenhagen, Denmark;
^{b}Endolase available under the tradename Celluclean 50001 from Novozymes, Copenhagen, Denmark;
^{c}Stain removal data lower standard deviation LSD = 3; high standard deviation HSD = 5;
^{d}Stain removal data lower standard deviation LSD = 2; high standard deviation HSD = 3;
e) Stain removal data lower standard deviation LSD = 2; high standard deviation HSD = 4

### Example 4. Graft Copolymer Examples

The following table, Table 4, shows illustrative, non-limiting examples of graft copolymers according to the present disclosure; see examples 4A-4C.

TABLE 4

| Graft | Monomer Ratio | | | PEG | | |
|---|---|---|---|---|---|---|
| Copolymer | (by wt) | | | Molecular | | VAc |
| Examples | PEG | VP | VAc | Weight (Da) | K-value | Hydrolysis |
| 4A | 1.00 | none | 1.5 | 6000 | * | <20% |
| 4B | 1.00 | 0.40 | 0.60 | 6000 | 23.5 | <20% |
| 4C | 1.00 | 0.40 | 0.60 | 6000 | 24.5 | 40% |

PEG = poly(ethylene glycol);
VP = vinyl pyrrolidone;
VAc = vinyl acetate

Synthesis Graft Copolymer 4A is described in WO 01/05874 and is available from BASF (Ludwigshafen, Germany).

### Synthesis of Graft Copolymer 4B

A polymerization vessel equipped with stirrer and reflux condenser is initially charged with 720 g of PEG (4000 g/mol) and 60 g ethyl acetate under nitrogen atmosphere. The mixture is homogenized at 70° C. Then, 432 g of vinyl acetate (in 2 h), 288 g of vinylpyrrolidone in 576 g of ethyl acetate (in 5 h), and 30.2 g of tert.-butyl perpivalate in 196.6 g ethyl acetate (in 5.5 h) are metered in. Upon complete addition of the feeds, the solution is stirred at 70° C. for 1 h. Subsequently, 3.8 g tert.-butyl perpivalate in 25.0 g ethyl acetate (in 1.5 h) were metered in followed by 0.5 h of stirring. The volatiles are removed by vacuum stripping. Then, 676.8 g deionized water are added and a steam distillation is conducted at 100° C. for 1 h. The resulting graft polymer is characterized by a K-value of 20.8. The solid content of the final solution is 48.8%. Polymer 4B is hydrolyzed to 4C.

### Example 5. ASTM Dust Sebum Removal Increases with 3.4% Graft Copolymer 4A and XYG, and Mannanase

Table 5 shows that the ASTM Dust sebum removal improves with the addition of 3.4% of graft copolymer 4A and mannanase and XYG (Example 5E). Example 5B with added mannanse or Example 5C with added mannanse and XYG has the same sebum removal as the comparative detergent example 5A. Addition of 3.4% of the graft copolymer 4A (Example 5D) has the same sebum removal as the comparative example 5A. Surprisingly, the combination of 3.4% graft copolymer 4A, mannanase, and XYG to detergent 1A (Example 5E) improves sebum stain removal by 9 units. Without being bound by theory, it is believed that the combination of Mannanase plus xyloglucanase surprisingly impacts sebum stains by complementing each other in a surprising manner to clean sebum at a level unattainable by each individual enzyme. Additionally, without being bound by theory, it is believed that the addition of the graft copolymer helps carry away the sebum in an unanticipated manner such that it significantly increases the removal of sebum stains.

TABLE 5

| | 3.4% Graft | | XYG | ASTM Dust | |
|---|---|---|---|---|---|
| | Copolymer | Mannanase | added to | Sebum | Sebum Removal |
| | Added to | added to | Detergent | Stain | Improvement vs |
| Example | Detergent 1A^{a} | Detergent 1A | 1A | Removal | 5A |
| 5A | None | none | none | 55 | Comparative |
| 5B | None | 0.001% | none | 54 | = |
| 5C | none | 0.001% | 0.01% | 57 | = |
| 5D | 4A | none | none | 60 | = |
| 5E | 4A | 0.001% | 0.01% | 64 | +9 |

^{a}Graft copolymer added to detergent composition 1A at 3.4%;
b) Stain removal data lower standard deviation LSD = 5; high standard deviation HSD = 8;

### Example 6. ASTM Dust Sebum Removal Increases with 3.4% Graft Copolymer 4B and XYG, and Mannanase

Table 6 shows that the ASTM Dust sebum removal improves by 10 units with the addition of graft copolymers 4B and mannanase and XYG (Example 6D) as compared to the detergent example 6A containing no additional mannanase and cellulase enzymes, and example 6B containing mannanase and XYG. Addition of the graft copolymer 4B without the mannanase and XYG (Example 6C) results in an improvement in sebum removal of 5 units and that improvement increases to 10 units with Example 6D containing the graft copolymer 4B, mannanase and XYG enzymes as shown in Table 6 below.

TABLE 6

| | Graft | | XYG | ASTM Dust | Dust Sebum |
|---|---|---|---|---|---|
| | Copolymer | Mannanase | added to | Sebum | Removal |
| | Added to | added to | Detergent | Stain | Improvement vs |
| Example | Detergent 1A^{a} | Detergent 1A | 1A | Removal | 6A |
| 6A | none | none | none | 53 | Comparative |
| 6B | none | 0.001% | 0.01% | 55 | = |
| 6C | 4B | none | none | 58 | +5 |
| 6D | 4B | 0.001% | 0.01% | 63 | +10 |

^{a}Graft copolymer added to detergent composition 1A at 6.8%;
b) Stain removal data lower standard deviation LSD = 3; high standard deviation HSD = 4;

### Example 7. Improved Sebum Removal with Graft Co-Polymer 4C

Table 7 shows that the PCS132 discriminating sebum removal improves with the addition of the graft copolymer 4C and mannanase and XYG. Example 7B shows that addition of 0.6% graft copolymer 4C and mannanase and XYG improves sebum removal by 11 units compared to the detergent example 7A containing 0.6% of graft copolymer 4A alone with no additional mannanase and cellulase enzymes. The sebum removal benefit increases further with 4.5% graft copolymer 4C and mannanase and XYG with a sebum removal benefit of 14 units compared to the comparative example 7A containing 0.6% graft copolymer 4A.

TABLE 7

| | | 0.001% | | |
|---|---|---|---|---|
| | | Mannanase and | | PCS132 Sebum |
| | Graft Copolymer | 0.01% XYG^{a} | PCS132 | Removal |
| | Added to Detergent | added to | Discriminating | Improvement vs |
| Example | 1B^{a} | Detergent 1B | Sebum Removal^{b} | 7A |
| 7A | 0.6% 4A | no | 49 | Comparative |
| 7B | 0.6% 4C | yes | 60 | +11 |
| 7C | 4.5% 4C | yes | 63 | +14 |

^{a}Xyloglucanase (XYG) available under the tradename Whitezyme from Novozymes, Copenhagen, Denmark;
^{b}Stain removal data lower standard deviation LSD = 4; high standard deviation HSD = 6.

### Test Methods

### Sebum Stain Removal Method

Technical stain swatches of CW120 cotton containing PCS132 Discriminating Sebum and PCS 94 ASTM Dust Sebum (available from Accurate Product Development, Fairfield, Ohio), are treated with a detergent composition of the present invention using the cotton short cycle wash setting on a Miele W174 WE FL washing machine. The machine uses a 13.1 L fill volume with 40° C. water for the wash and 15° C. water rinse cycles. The wash and rinse cycles use 15 grain per gallon water. The detergent composition (58 g) is added to the washing machine drum after the water is filled at the beginning of the wash cycle, and then two, CW120 stain swatches plus 2.9 kg of de-sized fabric ballast are added to the drum. The de-sized ballast is comprised of approximately 50% by weight of 100% cotton T-shirts (Gildan T-shirts, TCS Apparel), 25% by weight of 50% polyester/50% cotton pillowcases (Standard Textile Company) and 25% by weight of 86% cotton/14% polyester terry towels (Standard Textile Company). A total of eight stain swatches are averaged from 2 internal replicates from 4 different wash cycles for a total of eight CW120 swatches. Treated fabrics are dried in a cotton/high setting in a Kenmore series dryer.

Standard colorimetric measurement was used to obtain L*, a* and b* values for each stain before and after the washing. From L*, a* and b* values, the stain level was calculated by comparing the initial stain level before washing to the stain level after washing and accounting for the initial background corresponding to an unstained portion of the fabric.

Stain removal from the swatches was measured as follows:

$$Stain Removal Index ( S R I ) = \frac{Δ {E}_{initial} - Δ {E}_{washed}}{Δ {E}_{initial}} \times 100$$

ΔEᵢₙᵢₜᵢₐₗ=Stain level before washing−Unstained, unwashed portion of fabric
ΔE_{washed}=Stain level after washing−Unstained, unwashed portion of fabric

The SRI values are the averaged SRI values from the eight replicates. The stain level of the fabric before the washing (ΔEᵢₙᵢₜᵢₐₗ) is high; in the washing process, stains are removed and the stain level after washing is reduced (ΔE_{washed}). The better a stain has been removed, the lesser the value for ΔE_{washed} and the greater the difference between ΔEᵢₙᵢₜᵢₐₗ and ΔE_{washed} (ΔEᵢₙᵢₜᵢₐₗ−ΔE_{washed}). Therefore the value of the stain removal index increases with better washing performance.

### Examples

A. A detergent composition comprising a detergent ingredient, a mannanase enzyme at a level of from 0.0001% to 2% pure enzyme by weight of total composition and at least one cellulase enzyme.
B. The detergent composition of paragraph A, wherein the at least one cellulase enzyme is selected from the group consisting of endolase enzyme or xyloglucanase enzyme.
C. The detergent composition according any of paragraphs A-B, wherein the endolase enzyme is present at a level of from 0.0001% to 2% pure enzyme by weight of the composition.
D. The detergent composition according to any of paragraphs A-C, wherein the xyloglucanase enzyme is present at a level of from 0.0001% to 2% pure enzyme by weight of the composition.
E. The detergent composition according to any of paragraphs A-D, further comprising a surfactant selected from anionic, nonionic, cationic surfactant, and/or mixtures thereof.
F. The detergent composition according to any of paragraphs A-E, further comprising a bleaching agent.
G. The detergent composition according to any of paragraphs A-F, further comprising a builder, preferably a zeolite, a sodium layered silicate, sodium tripolyphosphate and/or mixtures thereof.
H. The detergent composition according to any of paragraphs A-G, wherein the composition further comprises a suspension graft copolymer.
I. The detergent composition according to paragraph H, wherein the suspension graft copolymer is selected from the group consisting of poly(vinylacetate)-g-poly(ethylene glycol), poly(vinylpyrrolidone)-poly(vinyl acetate)-g-poly(ethylene glycol), and combinations thereof.
J. The detergent composition according to paragraph I, wherein the graft copolymer comprises between 0 and 60% hydrolysis of the vinyl acetate units.
K. The detergent composition according to any of paragraphs A-J, wherein the composition further comprises a dye transfer inhibitor.
L. The detergent composition according to paragraph K, wherein the dye transfer inhibitor is selected from the group consisting of polyvinyl pyrrolidone polymers, polyamine N-oxide polymers, copolymers of N-vinylpyrrolidone and N-vinylimidazole, manganese phthalocyanine, peroxidases, and mixtures thereof.
M. The detergent composition according to any of paragraphs A to L, the composition further comprising a structurant.
N. The detergent composition according to any of paragraphs H to M, wherein the suspension graft copolymer is present at a level from about 0.1% to about 15% by weight of the composition.
O. A method of treating a fabric, comprising the step of contacting said fabric with said detergent composition of any of paragraphs A to N.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.”

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A detergent composition comprising a detergent ingredient, a mannanase enzyme at a level of from 0.0001% to 2% pure enzyme by weight of total composition and a cellulase enzyme.

2. The detergent composition of claim 1, wherein the cellulase enzyme is selected from the group consisting of endolase enzyme or xyloglucanase enzyme.

3. The detergent composition according to claim 2, wherein the endolase enzyme is present at a level of from 0.0001% to 2% pure enzyme by weight of the composition.

4. The detergent composition according to claim 2, wherein the xyloglucanase enzyme is present at a level of from 0.0001% to 2% pure enzyme by weight of the composition.

5. The detergent composition according to claim 1, further comprising a surfactant selected from anionic, nonionic, cationic surfactant, and/or mixtures thereof.

6. The detergent composition according to claim 1, further comprising a hueing dye.

7. The detergent composition according to claim 1, further comprising a builder, preferably a zeolite, a sodium layered silicate, citric acid, lactic acid, fatty acid, and/or mixtures thereof.

8. The detergent composition according to claim 1, wherein the composition further comprises a suspension graft copolymer.

9. The detergent composition according to claim 8, wherein the suspension graft copolymer is present at a level from about 0.1% to about 15% by weight of the composition.

10. The detergent composition according to claim 8, wherein the suspension graft copolymer is selected from the group consisting of poly(vinylacetate)-g-poly(ethylene glycol), d poly(vinylpyrrolidone)-poly(vinyl acetate)-g-poly(ethylene glycol), with hydrolysis of the vinyl acetate groups between 0 and 60%, and combinations thereof.

11. The detergent composition according to claim 8, the composition further comprising a structurant.

12. The detergent composition according to claim 1, wherein the composition further comprises a dye transfer inhibitor.

13. The detergent composition according to claim 12, wherein the dye transfer inhibitor is selected from the group consisting of polyvinyl pyrrolidone polymers, polyamine N-oxide polymers, copolymers of N-vinylpyrrolidone and N-vinylimidazole, manganese phthalocyanine, peroxidases, and mixtures thereof.

14. A detergent composition comprising a detergent ingredient, a mannanase enzyme at a level of from 0.0001% to 2% pure enzyme by weight of total composition and a graft copolymer.

15. The detergent composition of claim 14, wherein the composition further comprises a cellulase enzyme, wherein the cellulase enzyme is selected from the group consisting of endolase enzyme or xyloglucanase enzyme.

16. The detergent composition according to claim 15, wherein the endolase enzyme is present at a level of from 0.0001% to 2% pure enzyme by weight of the composition.

17. The detergent composition according to claim 15, wherein the xyloglucanase enzyme is present at a level of from 0.0001% to 2% pure enzyme by weight of the composition.

18. The detergent composition according to claim 14, further comprising a surfactant selected from anionic, nonionic, cationic surfactant, and/or mixtures thereof.

19. The detergent composition according to claim 14, further comprising a hueing dye.

20. The detergent composition according to claim 14, further comprising a builder, preferably a zeolite, a sodium layered silicate, citric acid, lactic acid, fatty acid and/or mixtures thereof.

21. The detergent composition according to claim 14, the composition further comprising a structurant.

22. The detergent composition according to claim 14, wherein the suspension graft copolymer is present at a level from about 0.1% to about 15% by weight of the composition.

23. The detergent composition according to claim 14, wherein the suspension graft copolymer is selected from the group consisting of poly(vinylacetate)-g-poly(ethylene glycol), poly(vinylpyrrolidone)-poly(vinyl acetate)-g-poly(ethylene glycol) with hydrolysis of the vinyl acetate groups between 0 and 60%, and combinations thereof.

24. The method of treating a fabric, comprising the step of contacting said fabric with said detergent composition of claim 1.
